(19) United States
(12) Patent Application Publication
(10) Pub. No.: US 2026/0328574 A1
(43) Pub. Date: Oct. 22, 2026

(54) Information Processing Apparatus, Terminal Device, Information Processing System, Information Processing Method, and Program

(71) Applicant: HAMPOSAKI INC., Tokyo (JP)

(72) Inventor: Toshihito KOBAYASHI, Tokyo (JP)

(73) Assignee: HAMPOSAKI INC., Tokyo (JP)

(21) Appl. No.: 19/696,449

(22) Filed: Jun. 3, 2026

Related U.S. Application Data
(63) Continuation of application No. PCT/JP2024/033788, filed on Sep. 23, 2024.

(30) Foreign Application Priority Data
Dec. 5, 2023 (JP) 2023-205490

(51) Int. Cl. G01C 21/34; G01C 21/36

(52) U.S. Cl. CPC G01C 21/3438; G01C 21/3617; G01C 21/362; G01C 21/3644

(57) ABSTRACT

An information processing apparatus includes: a storage unit in which group feature information is stored, the group feature information being associated with a group identifier corresponding to two or more user identifiers and being feature information regarding a map feature that has been previously recorded based on a state or an action of a user; a feature information acquisition unit that acquires, from the storage unit, the group feature information corresponding to the group identifier corresponding to the user identifier of the destination user; and a feature information output unit that outputs the acquired group feature information or information based on the group feature information as output information in association with the destination user. The information processing apparatus enables sharing of data on a map within a group including a plurality of users.

### CROSS-REFERENCE TO RELATED APPLICATION

This application is a continuation application under 35 U.S.C. 111(a) of International Patent Application PCT/JP2024/033788 filed on Sep. 23, 2024, and designated the U.S., which claims priority of Japan Patent Application No. 2023-205490 filed on Dec. 5, 2023, the entire contents of each are incorporated herein by reference.

### TECHNICAL FIELD

The present disclosure relates to an information processing apparatus, a terminal device, an information processing system, an information processing method, and a program capable of providing data on a map.

### BACKGROUND ART

Computers such as personal computers, smartphones, and other portable information terminals, as well as car navigation systems used in vehicles and the like, have become widespread, and users thereof are able to easily use map information.

Regarding the provision of such map information, for example, Patent Literature 1 below discloses transmitting location information and a search word from a terminal, receiving position and attribute information of stores or facilities, and displaying the received information on a map.

### CITATION LIST

### Patent Literature

Patent Literature 1: Japanese Patent Application Laid-Open No. 2018-142019

### SUMMARY

### Technical Problem

In a group such as a specific organization, a plurality of users within the group may perform activities related to a specific task or purpose together. In such a case, it would be convenient if the plurality of users could share, within the group, information about locations and features related to the activities.

An object of the present disclosure is to provide an information processing apparatus, a terminal device, an information processing system, an information processing method, and a program that enable sharing of data on a map within a group including a plurality of users.

### Solution to Problem

An information processing apparatus according to a first aspect of the present disclosure includes: a storage unit in which group feature information is stored, the group feature information being associated with a group identifier corresponding to two or more user identifiers and being feature information regarding a map feature that has been previously recorded based on a state or an action of a user; a feature information acquisition unit that acquires, from the storage unit, the group feature information corresponding to the group identifier corresponding to the user identifier, by using the user identifier of a destination user; and a feature information output unit that outputs the acquired group feature information or information based on the group feature information as output information in association with the destination user.

With such a configuration, data on a map can be shared within a group including a plurality of users.

Furthermore, an information processing apparatus according to a second aspect of the present disclosure, in addition to the first aspect, includes: a rule information acquisition unit that acquires input rule information that has been input by a user and that specifies at least one predetermined attribute for which an attribute value can be recorded regarding a feature, in association with the group identifier corresponding to the user identifier of the user; a rule information output unit that outputs, to a user corresponding to a user identifier associated with the group identifier, rule application information used for accepting input of an attribute value of the predetermined attribute in association with a feature, based on the input rule information; and a specific input information accumulation unit that acquires the attribute value input by the user based on the rule application information, and accumulates the acquired attribute value in the storage unit as the group feature information in association with the group identifier corresponding to the user identifier of the user.

With such a configuration, attribute values of predetermined attributes in accordance with the input rule information input by a user can be utilized within the group.

Furthermore, in an information processing apparatus according to a third aspect of the present disclosure, in addition to the second aspect, the specific input information accumulation unit is configured to acquire specific related information acquired in relation to the input of the attribute value, together with the attribute value of the predetermined attribute input by the user regarding the feature, and to accumulate the specific related information as the group feature information in the storage unit, and the feature information output unit acquires the output information regarding the map feature using the attribute value of the predetermined attribute and the specific related information, and outputs the output information in association with the destination user.

With such a configuration, output information utilizing the specific related information can be utilized within the group.

Furthermore, in an information processing apparatus according to a fourth aspect of the present disclosure, in addition to any one of the first to third aspects, the feature information output unit determines whether the group feature information acquired by the feature information acquisition unit satisfies a predetermined feature condition, and outputs the output information corresponding to the group feature information in an output mode corresponding to a determination result.

With such a configuration, output information can be output in an output mode corresponding to whether the feature condition is satisfied.

Furthermore, in an information processing apparatus according to a fifth aspect of the present disclosure, in addition to any one of the first to fourth aspects, the storage unit stores time information that enables specification of a time at which the group feature information was recorded, the feature information acquisition unit acquires, from the storage unit, two or more sets of the group feature information corresponding to one group identifier and the time information corresponding to the group feature information, the feature information output unit is configured to output the output information based on the information acquired by the feature information acquisition unit, and the output information includes information for displaying two or more pieces of the group feature information or information based on the group feature information in reverse chronological order.

With such a configuration, output information that enables data on a map to be indicated in chronological order can be output.

Furthermore, in an information processing apparatus according to a sixth aspect of the present disclosure, in addition to any one of the first to fifth aspects, the information processing apparatus includes: a list output unit that outputs a member list including user identifiers of one or more other users associated with the group identifier corresponding to the user identifier of a target user who is the destination user for the output information, such that the target user can confirm the member list; a mention operation acceptance unit that accepts a predetermined operation corresponding to an element on a map that is confirmable by the target user based on the output information, the predetermined operation being performed by the target user in association with one or more user identifiers included in the member list output by the list output unit; and a mention output unit that outputs, based on the acceptance result by the mention operation acceptance unit, information corresponding to the predetermined operation, in association with the user corresponding to the user identifier associated with the predetermined operation.

With such a configuration, information corresponding to a predetermined operation corresponding to an element on a map can be output to a specific other user within the group.

Furthermore, in an information processing apparatus according to a seventh aspect of the present disclosure, in addition to the sixth aspect, the storage unit stores state information regarding the state of each user in association with the user identifier of the user, and the list output unit is configured to perform a list construction process that constructs the member list in accordance with the state information corresponding to each of the user identifiers included in the member list, and to output the member list constructed by the list construction process.

With such a configuration, the member list can be confirmed in a mode corresponding to the state of each user.

Furthermore, an information processing apparatus according to an eighth aspect of the present disclosure, in addition to any one of the first to seventh aspects, includes: a position information accumulation unit that acquires position information indicating a position of a user, and accumulates the position information in the storage unit in association with the user identifier of the user; and a member information acquisition unit that acquires position information corresponding to the group identifier corresponding to the user identifier of the destination user from the storage unit, and acquires member information, which is information regarding other users of the group to which the destination user belongs, using the position information, and the feature information output unit outputs the member information together with the output information in association with the destination user.

With such a configuration, information regarding other users of the group to which the destination user belongs can be output.

Furthermore, in an information processing apparatus according to a ninth aspect of the present disclosure, in addition to the eighth aspect, the position information accumulation unit determines, using the acquired position information, whether a predetermined stay condition related to the position of the user or the movement of the user is satisfied, and when it is determined that the predetermined stay condition is satisfied, accumulates stay information in a predetermined mode in the storage unit in association with the user identifier of the user, and the member information acquisition unit acquires the position information and the stay information corresponding to the group identifier corresponding to the user identifier of the destination user from the storage unit, acquires the member information using the position information and the stay information, and the member information is configured such that information regarding the user corresponding to the stay information is output to the destination user in an output mode corresponding to the stay information.

With such a configuration, information regarding other users can be output in an output mode corresponding to the stay information.

Furthermore, in an information processing apparatus according to a tenth aspect of the present disclosure, in addition to any one of the first to ninth aspects, the group feature information is associated with a subgroup identifier capable of identifying a subgroup provided within the group, and the feature information acquisition unit is configured to acquire, from the storage unit, the group feature information corresponding to the group identifier corresponding to the user identifier of the destination user and associated with a subgroup identifier specifying an output target.

With such a configuration, data on a map shared within a subgroup provided within the group can be confirmed on the map.

Furthermore, a terminal device according to an eleventh aspect of the present disclosure includes: a display device; a map rendering information acquisition unit that acquires map rendering information indicating a map; an output information acquisition unit that acquires output information output from the information processing apparatus according to any one of the above aspects; and a terminal output unit that causes the display device to display information such that information based on the output information is displayed on a map, using the map rendering information and the output information.

With such a configuration, data on a map shared within the group can be confirmed on the map.

Furthermore, an information processing system according to a twelfth aspect of the present disclosure is an information processing system including an information processing apparatus and a terminal device communicable with the information processing apparatus and corresponding to one user identifier, the information processing system including: a storage unit in which group feature information is stored, the group feature information being associated with a group identifier corresponding to two or more user identifiers and being feature information regarding a map feature that has been previously recorded based on a state or an action of a user; a feature information acquisition unit that acquires, from the storage unit, the group feature information corresponding to the group identifier corresponding to the user identifier corresponding to the terminal device; an output information acquisition unit that acquires the acquired group feature information or information based on the group feature information as output information; a map rendering information acquisition unit that acquires map rendering information indicating a map; and a terminal output unit that outputs a map and information based on the output information to an output device provided in the terminal device, using the map rendering information and the output information.

With such a configuration, data on a map shared within a group including a plurality of users can be confirmed using the terminal device.

### ADVANTAGEOUS EFFECTS

According to the present disclosure, data on a map can be shared within a group including a plurality of users.

### BRIEF DESCRIPTION OF DRAWINGS

FIG. 1 is a diagram showing an overview of an information processing system according to one of the embodiments of the present disclosure.

FIG. 2 is a block diagram of the information processing system.

FIG. 3 is a block diagram of the information processing apparatus.

FIG. 4 is a diagram showing an example of user information stored in a user information storage unit of the information processing apparatus.

FIG. 5 is a diagram showing an example of group information stored in a group information storage unit of the information processing apparatus.

FIG. 6 is a diagram showing an example of information stored in a feature information storage unit of the information processing apparatus.

FIG. 7 is a flowchart showing an example of an operation of the information processing apparatus.

FIG. 8 is a flowchart showing an example of a stay information accumulation process performed by the information processing apparatus.

FIG. 9 is a flowchart showing an example of an output information output process performed by the information processing apparatus.

FIG. 10 is a flowchart showing an example of a list output process performed by the information processing apparatus.

FIG. 11 is a first flowchart showing an example of an operation of the terminal device.

FIG. 12 is a second flowchart showing an example of an operation of the terminal device.

FIG. 13 is a diagram illustrating one specific example of a map display screen of an application operating on the terminal device.

FIG. 14 is a diagram illustrating another specific example of a map display screen of an application operating on the terminal device.

FIG. 15 is a diagram illustrating one specific example of a group information display screen of an application operating on the terminal device.

FIG. 16 is a diagram illustrating one specific example of a timeline screen of an application operating on the terminal device.

FIG. 17 is a diagram illustrating one specific example of an aggregated list screen of an application operating on the terminal device.

FIG. 18 is an overview diagram of a computer system in the above embodiment.

FIG. 19 is a block diagram of the computer system.

FIG. 20 is a flowchart showing an example of an operation of the information processing apparatus according to a second variation of the present embodiment.

FIG. 21 is a first diagram illustrating screen display examples of an application operating on the terminal device in the second variation.

FIG. 22 is a second diagram illustrating screen display examples of the application.

FIG. 23 is a third diagram illustrating screen display examples of the application.

FIG. 24 is a fourth diagram illustrating screen display examples of the application.

FIG. 25 is a fifth diagram illustrating screen display examples of the application.

### DESCRIPTION OF EMBODIMENT

Hereinafter, embodiments of the information processing apparatus and the like will be described with reference to the drawings. In the embodiments, constituent elements denoted by the same reference signs perform the same operations, and thus redundant descriptions may be omitted.

The terms used below are generally defined as follows. The meanings of these terms should not always be interpreted as indicated herein, and should be interpreted also in light of explanations given individually below where applicable.

A feature refers to a natural object or an artificial object on the terrain. In the following embodiments, for example, houses, facilities, roads, certain points or areas themselves, and routes (which may also be called trajectories) passing through two or more points may be included in features. This is not limiting, and objects, phenomena, events, and the like in Earth space including the atmosphere, water, and underground may be interpreted as being included in features. For example, weather information and the like may be interpreted as being included in features. A feature may also be described as an entity that can be associated with a position specified by information specifying a position such as longitude, latitude, and altitude. A feature may also be called a geographic element or simply an element.

A user is a person who uses functions provided using the information processing apparatus. One user is typically one person, but this is not limiting. A unit that uses functions provided using the information processing apparatus as a single entity may be grasped as one user.

Two or more users may constitute a group. That is, a group is a collective composed of two or more persons. A group may also be called an organization or a team. The group may be constituted with an entire organization such as a company, a corporation, an association, an educational institution such as a school, a government office, a local government, or a union as one unit, or may be constituted on a per-department basis within such an organization. Furthermore, one or more users constituting one group may or may not have attributes in common with each other, in addition to constituting the group together.

A user constituting a group may also be called a member of the group. That is, a group is composed of two or more members.

Regarding the use of the information processing apparatus, it may or may not be permitted for one user to be included in each of two or more groups.

An identifier for a certain matter refers to a character or a code or the like that uniquely indicates the matter. The identifier is, for example, an ID, but the type is not limited as long as it is information that can identify the corresponding matter. That is, the identifier may be the name of what it indicates, or may be a combination of codes arranged in a unique correspondence.

Acquisition may include acquiring a matter input by a user or the like, or may include acquiring information stored in another device. Acquiring information stored in another device may include acquiring information stored in another device via an API or the like, or may include acquiring the content of a document file provided by another device (including content of a web page or the like) by performing scraping or the like. Furthermore, it may include acquiring information in a format different from original information based on the original information, such as acquiring information by performing optical character recognition on an image file.

Acquisition may include acquiring a matter input by a user or the like, or may include acquiring information stored in its own device or another device (which may be information pre-stored or information generated as a result of information processing in the device). Acquiring information stored in another device may include acquiring information stored in another device via an API or the like, or may include acquiring the content of a document file provided by another device (including content of a web page or the like). Furthermore, it may include acquiring information in a format different from original information based on the original information, such as acquiring information by performing optical character recognition on an image. For example, it may include acquiring information represented by a one-dimensional code or a multi-dimensional code or the like by reading the image of the code.

Furthermore, so-called machine learning techniques may be used for acquiring information. The use of machine learning techniques may be performed, for example, as follows. That is, a learner (learning information) that receives a specific type of input information as input and outputs a desired type of output information as output is constructed using a machine learning technique. For example, two or more sets of input information and output information are prepared in advance, the two or more sets of information are provided to a module for constructing a machine learning learner to construct the learner, and the constructed learner is accumulated in the storage unit. The learner may also be called a classifier. The machine learning technique may be, for example, deep learning, random forest, SVM, or the like without limitation. Furthermore, for machine learning, various functions in various machine learning frameworks such as fastText, tinySVM, random forest, and TensorFlow, and various existing libraries can be used. Acquiring information using such a learner may be referred to as acquisition by machine learning.

Furthermore, the learner is not limited to one obtained by machine learning. The learner may be, for example, a table indicating a correspondence between an input vector based on input information or the like and output information. In this case, output information corresponding to a feature vector based on the input information may be acquired from the table, or a vector approximating the feature vector based on the input information may be generated using two or more input vectors in the table and parameters for weighting the respective input vectors, and the final output information may be acquired using the output information corresponding to each input vector used in the generation and the parameters. Acquiring information using such a learner may be referred to as acquisition using a correspondence. Furthermore, the learner may be, for example, a function representing a relationship between an input vector based on input information or the like and information for generating output information. In this case, for example, information corresponding to the feature vector based on the input information may be obtained by the function, and the output information may be acquired using the obtained information. Acquiring information using such a learner may be referred to as acquisition using a function.

Outputting information is a concept that includes displaying on a display, projecting using a projector, printing by a printer, sound output, vibration output, light emission, transmission to an external device, accumulation in a recording medium, passing processing results to another processing device or another program, and the like. Specifically, it includes, for example, enabling display of information on a web page, transmitting as an e-mail or the like, and outputting information for printing.

Acceptance of information is a concept that includes acceptance of information input from an input device such as a keyboard, a mouse, or a touch panel, reception of information transmitted from another device or the like via a wired or wireless communication line, acceptance of information read from a recording medium such as an optical disk, a magnetic disk, or a semiconductor memory, and the like.

Regarding various types of information stored in the information processing apparatus or the like, updating is a concept that includes, in addition to changing stored information, adding new information to stored information, and deleting some or all of the stored information.

### Embodiment

An overview of the present embodiment is as follows. An information processing system using the information processing apparatus is one that enables sharing and management of data of features, such as data regarding features or data associated with features, among members belonging to a specific organization or group (feature information sharing function). The sharing of data and the like can be performed for each information sharing unit of all members of the organization or a subset thereof. For example, the output mode for data may be changed depending on whether the data of features shared within the group satisfies a feature condition.

Here, in the present embodiment, the following functions may each be available in the information processing system. For example, within the group, specific input information input in accordance with a predetermined input rule can be collected, and the collected specific input information can be utilized as shared data (specific input information acceptance function). Furthermore, for example, within the group, a user may be able to output data of features and designated information to another member selected using a member list (mention function). Furthermore, position information of each member of the group may be used to output member information regarding other members to one user (position acquisition function). In this case, when it can be determined that a predetermined stay condition has been satisfied based on position information of each member, stay information corresponding thereto may be accumulated, and member information indicating chronological changes in the state of other members may be output based thereon, or the member information may be output in an output mode corresponding to the stay information.

The shared data is output to the terminal device used by each user, and is output by a method recognizable by the user at the terminal device. In this case, for example, by displaying data of features on a map using map rendering information, the user can easily confirm the data of features. The output method is not limited to this.

Hereinafter, an example of the configuration of an information processing system using the information processing apparatus configured as described above will be described.

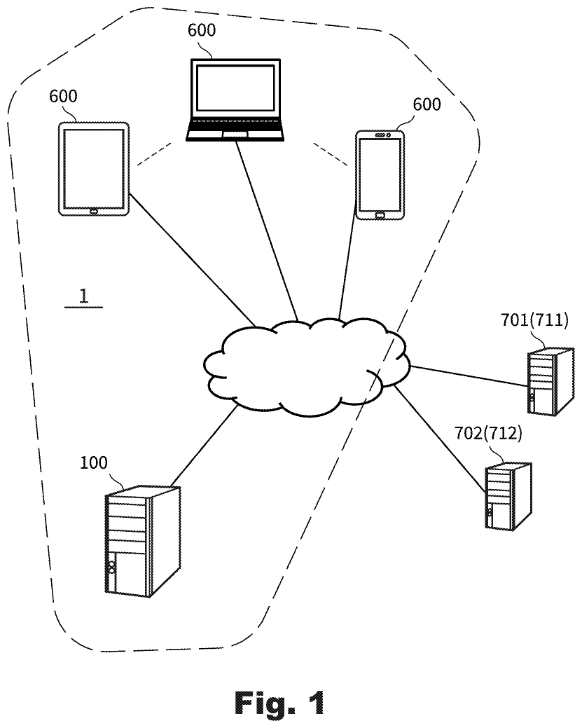

FIG. 1 is a diagram showing an overview of an information processing system 1 according to one of the embodiments of the present disclosure.

In the present embodiment, the information processing system 1 may be composed of an information processing apparatus 100 and a terminal device 600 owned by a user. The information processing system 1 is used by two or more users. That is, the information processing system 1 may include two or more terminal devices 600. Other devices may be included in the information processing system 1.

The information processing apparatus 100 and the terminal device 600 are communicable with each other via a network such as the Internet, for example.

The terminal device 600 is, for example, a portable information terminal device such as a so-called smartphone, but the device used as the terminal device 600 is not limited thereto. For example, it may be a tablet-type information terminal device, a smart watch, VR goggles, a personal computer (PC) such as a laptop computer, or a device other than these. The user can use the information processing system 1 by using the terminal device 600. In the following examples, description will be made assuming that a portable information terminal device such as a smartphone is used as the terminal device 600, but this is not limiting.

In the present embodiment, each device of the information processing system 1 is communicable via a network with external information providing devices 701, 702. Each device of the information processing system 1 can receive information transmitted from the information providing devices 701, 702. In the present embodiment, for example, a map providing device 701 and a processing information providing device 702 are used as the information providing devices 701, 702. These devices 701, 702 may not necessarily be used, and each device of the information processing system 1 may be configured to perform various operations using information held or acquired by the device.

In the present embodiment, the map providing device 701 is a server device and has a map rendering information storage unit 711. The map rendering information storage unit 711 stores map rendering information indicating a map. The map rendering information is, for example, information used by an application operating on the terminal device to render a map, and more specifically, is, for example, a data set including elements such as geographic coordinates, road shapes and names, building positions and heights, water areas and parks, and transportation means. This is not limiting, and the information included in the map rendering information and its format are not limited. The map providing device 701 is configured to be able to provide the map rendering information to the information processing apparatus 100 or the terminal device 600.

The map providing device 701 is, for example, a server operated by an external organization that provides a map information service, but this is not limiting. The map providing device 701 may be included in the information processing system 1.

The processing information providing device 702 is a server device and has a processing information storage unit 712. The processing information storage unit 712 stores processing information regarding features. The processing information is, for example, measurement data or statistical data prepared in advance for specific features. The processing information may also be described as information that is additionally used when performing a predetermined process on one feature, and information used for determination when a predetermined process involving determination is performed may correspond to the processing information, for example. The processing information is, for example, stored in association with a feature identifier capable of identifying a feature, but this is not limiting. For example, the processing information may be stored in association with a position specified by longitude, latitude, altitude, or the like, or an area divided by a predetermined method. The processing information providing device 702 is configured to be able to provide, to the information processing apparatus 100, processing information corresponding to a feature identifier, a position, or an area. More specifically, the processing information is, for example, soil component analysis results, water quality survey data, traffic flow, population dynamics such as population density, weather information such as temperature and atmospheric pressure, tidal current information regarding tidal currents, reception intensity of radio waves for mobile phones, commercial activity indicators, and the like, but is not limited thereto.

The processing information providing device 702 is, for example, a server operated by a public institution or a research institution that compiles surveys and statistics regarding features, but this is not limiting. The processing information providing device 702 may be included in the information processing system 1.

The information providing devices 701, 702 may be communicable with the information processing apparatus 100 or the like by being connected to the same network as the information processing apparatus 100, the terminal devices 600, and the like, or may be communicably connected to the information processing apparatus 100 or the like via a network different from that network. In this case, information of the information providing devices 701, 702 may be transmitted to the information processing apparatus 100 so that the information is managed by the information processing apparatus 100.

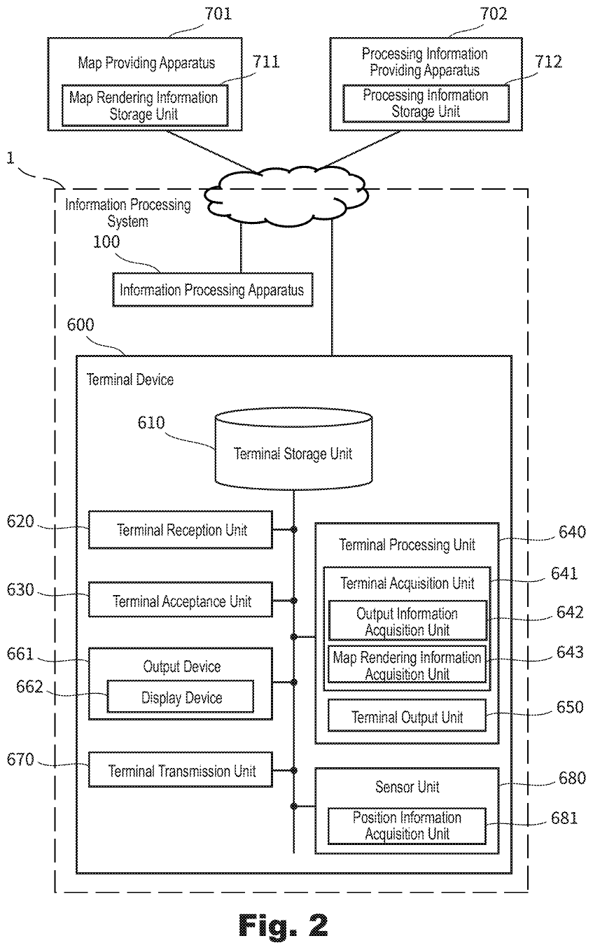

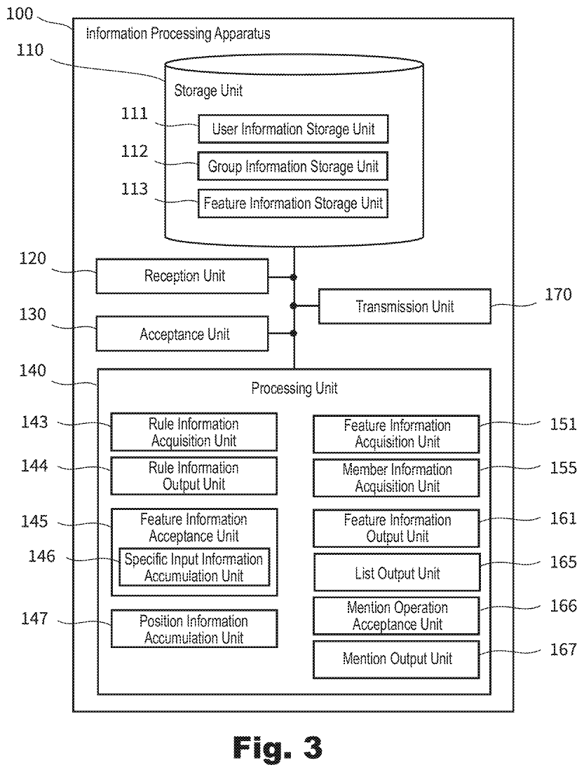

FIG. 2 is a block diagram of the information processing system 1. FIG. 3 is a block diagram of the information processing apparatus 100.

With reference to FIG. 2, the configuration of the terminal device 600 will be described. The terminal device 600 includes a terminal storage unit 610, a terminal reception unit 620, a terminal acceptance unit 630, a terminal processing unit 640, an output device 661, a terminal transmission unit 670, and a sensor unit 680.

The terminal storage unit 610 stores information used for the operation of the terminal device 600 and information acquired by the terminal device 600.

In the present embodiment, the terminal storage unit 610 stores a user identifier capable of identifying the terminal device 600. The user identifier is information capable of identifying the user who uses the terminal device 600. As the user identifier, various identifiers can be used, such as an identifier unique to each terminal device 600, an identifier unique to one piece of software operating on the terminal device 600 (e.g., an identifier identifying an account logged in for a function realized by the software), an identifier identifying an account in a web service usable by using the terminal device 600, and the like. More specifically, as the user identifier, various information can be used, such as account information of a user of an operating system that operates the terminal device 600, account information logged into a web service accessible by a web browsing function realized on the terminal device 600, and cookies given from a web page accessed by the web browsing function.

The terminal reception unit 620 receives, via a network, information transmitted from the information processing apparatus 100 and other devices. The terminal reception unit 620 accumulates the received information, for example, in the terminal storage unit 610 so that the terminal processing unit 640 and the like can acquire the information.

The terminal acceptance unit 630 accepts various input operations by the user who uses the terminal device 600 with respect to the terminal device 600. The operations are performed, for example, using an input device (not shown), but this is not limiting. The terminal acceptance unit 630 may be configured to accept, for example, an input operation by voice input through a microphone.

The terminal processing unit 640 performs various information processing operations using each unit of the terminal device 600.

In the present embodiment, the terminal processing unit 640 has a terminal acquisition unit 641 and a terminal output unit 650.

The terminal acquisition unit 641 acquires, for example, information received by the terminal reception unit 620 and information accepted by the terminal acceptance unit 630. The terminal acquisition unit 641 has, for example, an output information acquisition unit 642 and a map rendering information acquisition unit 643.

The output information acquisition unit 642 acquires, as output information, group feature information or information based on the group feature information as described later. In the present embodiment, as described later, the group feature information or information based on the group feature information is output as output information from the information processing apparatus 100. That is, in the present embodiment, the output information acquisition unit 642 acquires the output information output from the information processing apparatus 100.

The map rendering information acquisition unit 643 acquires map rendering information. In the present embodiment, the map rendering information acquisition unit 643 acquires the map rendering information from the map providing device 701.

The terminal output unit 650 outputs a map and information based on the output information to the output device 661, using the map rendering information and the output information. As a result, the output device 661 can output the map and the information based on the output information using these pieces of information. In the present embodiment, the terminal output unit 650 causes the display device 662 to display information such that information based on the output information is displayed on a map, using the map rendering information and the output information. As a result, the user can see and confirm the information based on the output information displayed on the map. The terminal output unit 650 may output information such that the information based on the output information is displayed at a position not on the map. Even in this case, the user can easily confirm the information based on the output information displayed together with the map. Being displayed together with the map may include a display mode in which the map is not displayed simultaneously. For example, when an operation specifying a feature is performed on a screen on which the map is displayed, information based on the output information corresponding to the feature may be displayed.

The output device 661 includes a display device 662 that is a display device. The output device 661 outputs information by, for example, displaying on the display device 662. The method of outputting information is not limited thereto, and may be performed by a method of outputting sound or the like from a speaker, a method of vibrating, a method of emitting light, or the like.

The terminal transmission unit 670 transmits information acquired by the terminal processing unit 640 and the like via a network.

The sensor unit 680 detects a detection target and outputs obtained information. The obtained information is accumulated, for example, in the terminal storage unit 610 and the like.

In the present embodiment, the sensor unit 680 includes a position information acquisition unit 681. The position information acquisition unit 681 is, for example, a position information sensor capable of specifying a position by GPS or the like. The position information acquisition unit 681 may also be called a positioning unit. The sensor unit 680 may also be described as acquiring position information of the user. A reading device or a measurement device different from this may be used as the sensor unit 680.

The terminal device 600 transmits information to the information processing apparatus 100 via the terminal transmission unit 670, based on the operation of the user accepted by the terminal acceptance unit 630. For example, the terminal device 600 transmits the acquired position information to the information processing apparatus 100. Furthermore, for example, the terminal device 600 transmits information input by the user to the information processing apparatus 100. Preferably, these pieces of information are transmitted in association with the user identifier stored in the terminal storage unit 610. That is, it is preferable that the terminal device 600 transmits, to the information processing apparatus 100, the user identifier capable of identifying the user who uses the terminal device 600, in association with the information to be transmitted.

The terminal storage unit 610 may store a group identifier corresponding to the user identifier. The terminal device 600 may transmit, to the information processing apparatus 100, the group identifier capable of identifying the group to which the user who uses the terminal device 600 belongs, in association with the information to be transmitted.

Next, the configuration of the information processing apparatus 100 will be described.

As shown in FIG. 3, the information processing apparatus 100 includes a storage unit 110, a reception unit 120, an acceptance unit 130, a processing unit 140, and a transmission unit 170. The information processing apparatus 100 is, for example, a server device.

The storage unit 110 includes a user information storage unit 111, a group information storage unit 112, and a feature information storage unit 113.

The user information storage unit 111 stores user information regarding users. In the present embodiment, the user information is stored in association with a user identifier that identifies a user who uses the information processing system 1. The user information may include various types of information. For example, acquired position information, state information regarding the state of the user, attribute values of other attributes, and the like may be included in the user information. The state information is, for example, information indicating whether the user is available to respond to calls from other users, information indicating whether the user is working, is on standby, is on a break, or is off, information indicating whether the user is going or returning, and the like, but is not limited thereto. The user information may include, for example, information acquired by a wearable terminal or the like worn by the user, information acquired from an external database or the like in which user information is recorded, and the like. Furthermore, the state information may change automatically based on the position, direction of movement, travel time, and the like of the user. Furthermore, the user information may be updated using information transmitted from the user, information acquired by the processing unit 140, and the like.

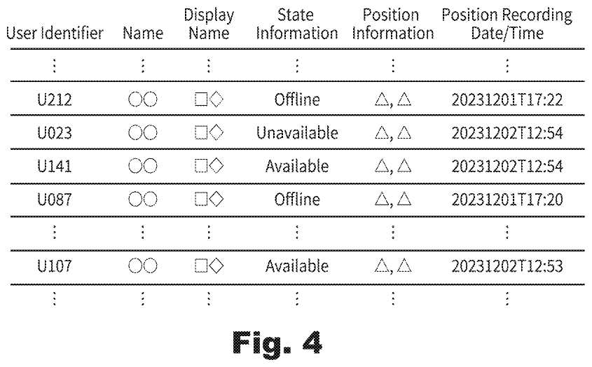

FIG. 4 is a diagram showing an example of user information stored in the user information storage unit 111 of the information processing apparatus 100.

In the example shown in the figure, the user information includes, for example, attribute values such as the name of the user, the display name, state information, and the latest acquired position information, recorded in association with the user identifier. Information indicating the date and time at which the position information was acquired may also be recorded. For example, regarding position information, a past history may be recorded. That is, position information indicating a route traced by the user may be recorded.

In the present embodiment, a plurality of sets of information such as position information and its acquisition date and time may be recorded, or only a predetermined number of combinations matching a predetermined rule may be recorded. The predetermined rule may be, for example, the earliest acquired, the latest acquired, those within a predetermined period from acquisition, and the like, and may be set as appropriate. Furthermore, as described later, stay information may be recorded in association with the position information.

Returning to FIG. 3, the group information storage unit 112 stores group information regarding each group. In the present embodiment, the group information is stored in association with a group identifier that identifies a group. The group information includes, for example, user identifiers of each of two or more users who are members of the group. In the present embodiment, the group information includes permission information specifying permissions possessed by each member of the group. The permission information is, for example, information indicating an association between information specifying a permission and the user identifier of a user having the permission, but is not limited thereto. The permissions are, for example, permissions regarding management operations of the group, addition/deletion of members, name changes, addition/editing/deletion of subgroups, addition/editing/deletion of input rule information, and viewing of statistical information, but are not limited thereto. Furthermore, the group information may include, for example, input rule information defining rules as described later.

Furthermore, subgroup information indicating subgroups included in the group may be stored as the group information. The subgroup may be provided as one or more within one group, and each subgroup may be configured to include one or more users among the two or more users constituting one group. A subgroup may be described as a subset of the members of the group. A subgroup may not be provided within one group. The subgroup may be provided for each specific project within the group, or for each unit of a set of users such as a department, a division, a team, a charge, or a section. A subgroup may also be called a channel of the group.

The subgroup information is stored in association with the group identifier. In the present embodiment, the subgroup information may include, for example, user identifiers of members belonging to the subgroup, associated with a subgroup identifier that identifies the subgroup. The subgroup information may include, for example, the display name of the subgroup, setting information such as whether information is viewable by members outside the subgroup, and the like. The subgroup identifier may be an identifier capable of identifying one subgroup from other groups within one group, or may be an identifier capable of identifying a subgroup throughout the information processing system 1.

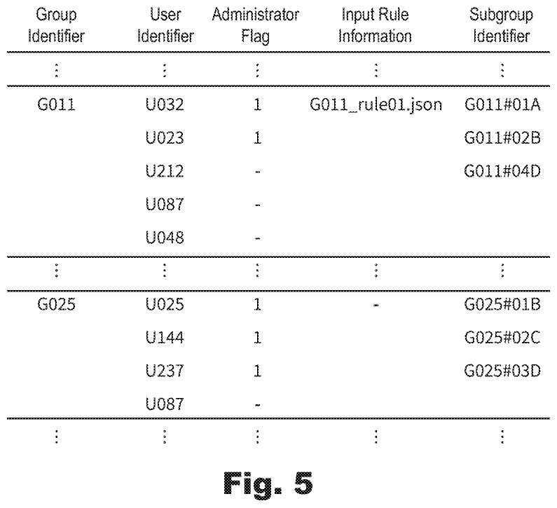

FIG. 5 is a diagram showing an example of group information stored in the group information storage unit 112 of the information processing apparatus 100.

In the example shown in the figure, the group information includes, for example, user identifiers of members of the group and flag information that enables specification of whether each member has administrator privileges, recorded in association with the group identifier. The method of categorizing permissions and the specific content of each permission are not limited thereto. In the group information, for example, the members of the group may be recorded in association with the group identifier, classified by their respective permissions. For example, when there are two types of permissions, namely being an administrator or being permitted only to view, the user identifiers of members who are administrators and the user identifiers of members who are permitted only to view may be recorded separately.

Furthermore, in the example shown in the figure, when an input rule is used in the group, the input rule information is recorded in association with the group identifier of the group. The input rule information is, for example, stored in the storage unit 110 as a file in JSON format or the like, and is identifiable by the group identifier. The method of managing the input rule information is not limited to this.

Furthermore, in the example shown in the figure, subgroup information about subgroups set in the group is recorded in association with the group identifier of the group. As the subgroup information, for example, subgroup identifiers are recorded, but this is not limiting. Other information may be included in the subgroup information.

Returning to FIG. 3, the feature information storage unit 113 stores group feature information used in each group. In the present embodiment, the group feature information is associated with a group identifier corresponding to two or more user identifiers, and is feature information regarding a map feature that has been previously recorded based on a state or an action of a user. For example, the group feature information includes feature information recorded based on an input by a user who is a member of the group and associated with the user identifier of the user who made the input. The input by the user may refer to specifying a specific feature. The feature information included in the group feature information may include feature information recorded based on detection results such as the user being in a predetermined state. Furthermore, the feature information may include feature information recorded based on an action of the user, such as the user having moved.

In the present embodiment, the group feature information may be associated with a subgroup identifier. This makes it possible to specify which group's information and which subgroup's information within the group each piece of feature information belongs to. The group feature information may be associated with a user identifier, and the user identifier may be associated with a subgroup identifier, and in this case, the group feature information may be regarded as being associated with the subgroup identifier corresponding to the user identifier.

The feature information is information regarding a feature. The feature information includes, for example, information capable of identifying a feature. The feature information may also include other information regarding the map feature. In the present embodiment, the feature information may include, for example, position information such as longitude and latitude indicating the position of the feature, the name of the feature, information indicating the type of the feature, and user-input feature information specified by the user regarding the feature. The name of the feature may be, for example, a display name when displayed to a user, or a code used within the group to indicate the feature. The type of the feature is, for example, a classification result according to a classification method of features set in advance. For example, a classification method such as road, intersection, shop, residence (detached house), residence (apartment building), station, mountain, harbor, temple/shrine, and the like may be used, but this is not limiting. A classification method indicating whether the type of the feature represents an area, a surface, a boundary line, or the like, and a classification method such as administrative divisions, may also be used. As the user-input feature information, for example, specific input information input as described later, input text that is text information input by the user, tag information specifying a tag tagged by the user, and the like may apply. When classification of a feature is performed by the user using the classification method used as the type of the feature described above, the information may also be treated as information indicating the type of the feature.

In such feature information, for example, position information, or a combination of the position information and the name, can be used as information capable of identifying a feature. Any of these pieces of information that is not information capable of identifying a feature may not be included in the feature information. Furthermore, the feature information may be associated with a feature identifier that identifies the feature. The feature identifier may be an identifier that can identify a feature within the same group, or may be an identifier that can identify a feature throughout the information processing system.

Information specifying the accessibility of each member to the information may be included for each piece of feature information. For example, user identifiers identifying members to whom access is permitted or members not to be permitted access, and information specifying accessible permissions, may be included.

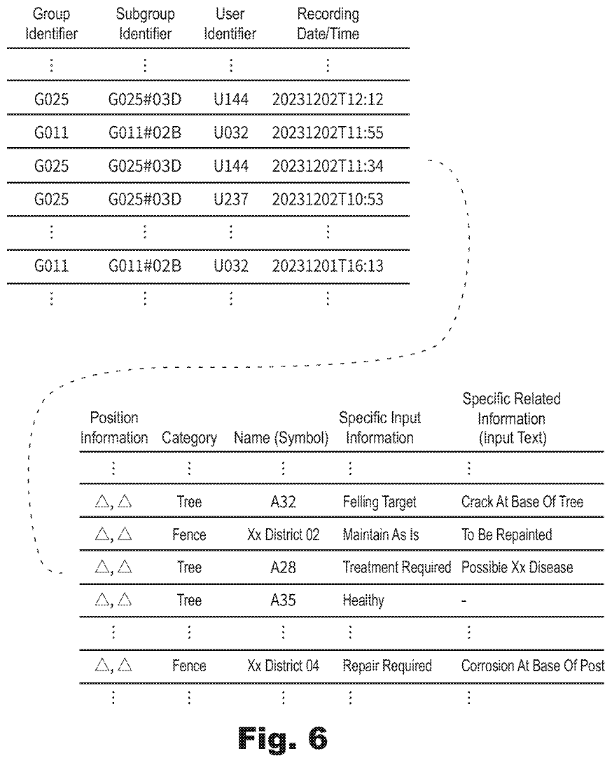

FIG. 6 is a diagram showing an example of information stored in the feature information storage unit 113 of the information processing apparatus 100.

In the example shown in the figure, the group feature information includes, for example, the user who input the information, the date and time of recording, and information indicating the specific content of the feature information, included in association with the group identifier. Furthermore, each piece of feature information is included in association with a subgroup identifier. As the information indicating the specific content of the feature information, for example, position information of the feature, the name, user-input feature information, and the like may be included, but are not limited thereto.

In the example shown in the figure, for example, for each group, feature information recorded by accepting input of attribute values as specific input information for features that are trees, and feature information recorded by accepting input of specific input information for features that are fences, are shown. For example, regarding the group identified by “G025” used for the purpose of a street tree survey, specific input information such as “treatment required,” “to be felled,” or “healthy” for features of the type “tree” has been selected from options defined in input rule information accepted in advance. Furthermore, for example, specific input information such as “maintain current state” or “repair required” regarding the group identified by “G011” has also been selected from options defined in input rule information accepted in advance. In the figure, information input by the user together with each piece of specific input information is recorded as input text.

By using such group feature information, it is possible to identify information such as feature information recorded in one group. The storage mode of the group feature information is not limited to this.

Returning to FIG. 3, the reception unit 120 receives information transmitted from other devices. The reception unit 120 saves the received information, for example, in the storage unit 110.

In the present embodiment, the user inputs information and the like using the terminal device 600 and transmits the information to the information processing apparatus 100. The reception unit 120 can save each piece of transmitted information in the storage unit 110 in association with the user identifier. When the reception unit 120 receives information from the terminal device 600, the reception unit 120 can identify the user identifier of the user associated with the transmission based on the transmitted information.

The acceptance unit 130 accepts information input using input means (not shown) connected to the information processing apparatus 100. The acceptance unit 130 accepts, for example, operations by an administrator or the like of the information processing apparatus 100. The acceptance unit 130 saves the accepted information, for example, in the storage unit 110.

The acceptance unit 130 may also be described as accepting information received by the reception unit 120 as information input to the information processing apparatus 100. The acceptance unit 130 may be described as accepting operations of the user performed using the terminal device 600. That is, input of information to the information processing apparatus 100 by the user may be interpreted as meaning that the information is indirectly input to the information processing apparatus 100 by the user via the terminal device 600 or the like, or may be interpreted as meaning that the information is directly input to the information processing apparatus 100 by the user using the input means. Furthermore, the user may cause a program that automatically generates information to execute, or give various types of information to the program to make it function, thereby providing information to the information processing apparatus 100, and this may be grasped as input of information to the information processing apparatus 100. Input of information by the administrator or the like of the information processing apparatus 100 can be grasped in the same manner.

The processing unit 140 includes a rule information acquisition unit 143, a rule information output unit 144, a feature information acceptance unit 145, a position information accumulation unit 147, a feature information acquisition unit 151, a member information acquisition unit 155, a feature information output unit 161, a list output unit 165, a mention operation acceptance unit 166, and a mention output unit 167. The feature information acceptance unit 145 includes a specific input information accumulation unit 146.

The processing unit 140 performs various types of processing. The various types of processing are, for example, processing performed by each unit of the processing unit 140 as described below.

The rule information acquisition unit 143 acquires input rule information input by a user in association with the group identifier corresponding to the user identifier of the user. The rule information acquisition unit 143 records the acquired input rule information in the group information storage unit 112 in association with the group identifier.

The input rule information is information that specifies at least one predetermined attribute for which an attribute value can be recorded regarding a feature. The predetermined attribute can be set as appropriate for each group according to the properties of the features to be targeted for acceptance of attribute values of the predetermined attribute and the purpose of collecting attribute values. That is, in the present embodiment, by setting a feature input rule (which may also be called an evaluation rule) for each group, each group can independently handle attribute values of required attributes as feature information. Hereinafter, the attribute value of the predetermined attribute defined by the input rule information may be referred to as specific input information. The specific input information may also be described as information input in accordance with the input rule information. For example, input rule information regarding inspection work on trees (an example of a feature) arranged in parks or the like may enable recording of attribute values of predetermined attributes such as tree species, tree height, outer circumference length, unit of length, need for maintenance or work, presence or absence of disease and its disease name, inspection date, inspection time, and the like. Furthermore, for example, input rule information regarding fences (an example of a feature) installed on public roads or the like may define attribute values of predetermined attributes such as the need for repair work and the required repair content to be recordable. The input rule information is, for example, information that defines attribute values that can be accepted as input for these predetermined attributes. The input rule information may be information that defines the data type of the predetermined attribute, or information that sets input restrictions that can be accepted. In this case, the input rule information may be described as defining values that the attribute can take, such as possible values in the case of options, whether symbols are permitted or not, whether Japanese or other languages are permitted or not, and the number of characters in the case of text, decimal/integer/range of values/whether negative values are permitted in the case of numerical values, Boolean values, date and time, or whether null values are permitted. The input rule information may be information that defines an evaluation method from a predetermined viewpoint regarding a feature.

The input rule information may include information indicating acceptance conditions regarding attributes of features used to identify features targeted for acceptance of specific input information. The acceptance conditions regarding attributes of features may be, for example, that the type of the feature targeted for acceptance of specific input information is a predetermined type, or that the feature targeted for acceptance of specific input information is in a predetermined area, but are not limited thereto.

In the present embodiment, the rule information acquisition unit 143 may be configured to acquire processing rule information input by the user in association with the input rule information. The processing rule information is, for example, information that defines a processing method using the specific input information and predetermined processing information. The processing rule information may also be called, for example, processing method identification information.

The rule information output unit 144 outputs, to a user corresponding to the user identifier associated with the group identifier, rule application information based on the acquired input rule information. That is, when a member inputs specific input information regarding a feature in one group, the rule information output unit 144 outputs the rule application information. The rule information output unit 144 constructs the rule application information based on the input rule information. The rule application information is transmitted to the terminal device 600 used by the member, and is used at the time of input of the specific input information. That is, the rule application information is information used for accepting, from the user, input of the specific input information regarding the predetermined attribute in association with a feature.

The rule application information is, for example, information for causing the terminal device 600 to output options of attribute values that can be accepted as specific input information regarding a type of feature targeted for input of specific input information, and information defining a range of attribute values that can be accepted as input, but is not limited thereto. The rule application information may be a determination condition for determining whether information is acceptable as specific input information.

The feature information acceptance unit 145 is configured to accept feature information input by a user and accumulate the information in the storage unit 110. The feature information acceptance unit 145 is configured to accept the feature information in association with the group identifier corresponding to the user identifier of the user who input the feature information, and to be able to accumulate the information in the feature information storage unit 113 as group feature information.

The feature information acceptance unit 145 is configured to acquire specific input information by the specific input information accumulation unit 146. The specific input information accumulation unit 146 acquires an attribute value, that is, specific input information, input by the user based on the rule application information output by the rule information output unit 144. The unit then accumulates the acquired specific input information in the feature information storage unit 113 as group feature information in association with the group identifier corresponding to the user identifier of the user who made the input.

In the present embodiment, the specific input information accumulation unit 146 is configured to be able to acquire specific input information input by the user regarding a feature and specific related information corresponding to the specific input information. The specific input information accumulation unit 146 may also be described as being capable of acquiring specific related information that is information related to the input of the attribute value that is the specific input information. The specific input information accumulation unit 146 is configured to accumulate the acquired specific related information in the storage unit 110 as group feature information together with the corresponding specific input information.

The specific related information is, for example, information input by the user together with the input of the specific input information, that is, information input or the like by the user and transmitted in association with the specific input information. For example, input text as shown in the example of FIG. 6 described above may be used as the specific related information. The specific related information is not limited thereto, and may be, for example, information acquired from the terminal device 600 or the like at the time of input. For example, it may be position information acquired at the time of input of the specific input information. Furthermore, the specific related information may be information regarding the user who made the input, for example, state information of the user, information regarding the age and career of the user, information regarding results of a questionnaire previously given to the user, and the like. An image captured by a camera provided on the terminal device 600 may be used as the specific related information. The specific related information may also simply be called supplementary information.

By the rule information acquisition unit 143, the rule information output unit 144, and the feature information acceptance unit 145 as described above, feature information for realizing the above-described specific input information acceptance function is accumulated for each group.

The position information accumulation unit 147 acquires position information indicating the position of a user, and accumulates the position information in the storage unit 110 in association with the user identifier of the user. In the present embodiment, the position information and information such as the date and time at which the position information was acquired are accumulated in the user information storage unit 111, but this is not limiting. The position information accumulation unit 147 acquires the position information transmitted periodically from the terminal device 600, for example, but this is not limiting. For example, the position information accumulation unit 147 may issue a transmission request for the position information to the terminal device 600, whereby the position information is transmitted from the terminal device 600.

In the present embodiment, the position information accumulation unit 147 has the following stay information accumulation function. That is, the position information accumulation unit 147 determines, using the acquired position information, whether a predetermined stay condition is satisfied. Then, when the position information accumulation unit 147 determines that the predetermined stay condition is satisfied, it accumulates stay information of a predetermined mode in the storage unit 110 in association with the user identifier of the user. The position information accumulation unit 147 may be configured to accumulate the stay information acquired for each user in association with the group identifier of the group of the user as group information or group feature information. In this case, the position information accumulation unit 147 may be configured to accumulate the position information acquired for each user in association with the group identifier of the group of the user as group information or group feature information.

In the present embodiment, the predetermined recording condition may be a stay condition related to the position of the user or the movement of the user. The stay condition may be, for example, a condition regarding a comparison result between a movement distance of the user from a predetermined time ago and a predetermined threshold value. More specifically, it may be, for example, that the movement distance within a predetermined time is smaller than a predetermined threshold value, or that the distance from a predetermined point does not exceed a certain threshold value for a predetermined time or more. Furthermore, the stay condition may be a condition regarding a relationship between the position of the user at a predetermined time and a predetermined position, for example, that the user has not departed from a predetermined area (or a position) even at a predetermined time. Furthermore, the stay condition may be, for example, that the user has not arrived at a predetermined point or area even at a predetermined time. The predetermined recording condition may be updated as appropriate in accordance with, for example, the time zone, the situation of individual users, and the like, or may include conditions regarding the situation of the users. The situation of individual users may be, for example, the user's next task (which may be a visit destination or a check-in destination), the content of the current task, the achievement status of the task, and the like. In this case, the situation of individual users may be identified, as long as it is identifiable, by information accumulated in the storage unit 110 in association with the user identifier, information that can be acquired from the terminal device 600 as appropriate, and the like.

Furthermore, in the present embodiment, the stay information of the predetermined mode may be information of a predetermined mode regarding the situation of the user's position or the situation of the user's movement. The stay information is, for example, the time and information corresponding to the recording condition that has been satisfied. The information corresponding to the recording condition that has been satisfied is, for example, the following information. That is, when a stay condition corresponding to having stayed in a predetermined area for a certain period of time is used as the predetermined recording condition, information indicating that the user has stayed in the area and the time zone thereof can be used as the stay information. In this case, information regarding a feature corresponding to the area and information indicating that the user has visited the feature and the time zone of the visit may be used as the stay information. Furthermore, for example, when a stay condition corresponding to having visited a feature corresponding to the user's task is used as the predetermined recording condition, information indicating that the task has been completed or that the user is working on the task can be used as the stay information.

The feature information acquisition unit 151 acquires, from the storage unit 110, group feature information corresponding to the group identifier of the group to be processed. In the present embodiment, when outputting output information as described later, the feature information acquisition unit 151 identifies the group identifier corresponding to the user identifier by using the user identifier of the destination user. In other words, the feature information acquisition unit 151 identifies the group of the destination user. Then, the feature information acquisition unit 151 acquires the group feature information corresponding to the group identifier from the feature information storage unit 113.

The feature information acquisition unit 151 may be configured to acquire, from the storage unit 110, the group feature information corresponding to the group identifier corresponding to the user identifier of the destination user and associated with a subgroup identifier specifying an output target. The subgroup identifier specifying an output target is, for example, a subgroup identifier of a subgroup designated by the destination user or the like, but may be a subgroup identifier identified in advance by a different method. This makes it possible, when outputting the output information as described later, to acquire the group feature information shared within the subgroup and to construct the output information.

In the present embodiment, when outputting the output information, the member information acquisition unit 155 acquires member information of the group to which the destination user belongs, prior to the output. The member information may also be described as, for example, information regarding other members of the group of the destination user.

In the present embodiment, the member information includes, for example, information indicating the position of each member. That is, the member information acquisition unit 155 acquires, from the storage unit 110, position information corresponding to the group identifier corresponding to the user identifier of the destination user. The position information corresponding to the group identifier may be described as position information corresponding to each of the user identifiers of users corresponding to the group identifier. The member information acquisition unit 155, for example, identifies user identifiers of other users corresponding to the group identifier, and acquires position information corresponding to each user identifier from the user information storage unit 111. When the position information of the user is also stored as group information or group feature information, the member information acquisition unit 155 may acquire the position information from the group information or the group feature information corresponding to the group identifier. Then, the member information acquisition unit 155 acquires the member information using the position information of each user.

The position information acquired by the member information acquisition unit 155 is, for example, the latest position information currently recorded, but this is not limiting. The member information acquisition unit 155 may acquire position information at a predetermined past timing.

The member information may include, for example, in addition to the position information of individual users, information that can be acquired using the position information. For example, information about the feature corresponding to the position information may be included in the member information. Furthermore, for example, member information including information indicating whether each user is in a predetermined feature or a predetermined area, or member information including information regarding users within a predetermined distance range from the destination user or a predetermined feature may be acquired. The member information may include the display name, icon image, and the like of each user.

Furthermore, for example, the member information acquisition unit 155 may acquire, using the position information of the destination user, information indicating the distance or route to each user, and acquire member information including the acquired information.

Furthermore, the member information may include information corresponding to the position information and the stay information. That is, the member information acquisition unit 155 may acquire the position information and the stay information corresponding to the group identifier from the storage unit 110, and acquire the member information using the position information and the stay information. The stay information corresponding to the group identifier may be described as stay information corresponding to each of the user identifiers of users corresponding to the group identifier. The member information acquisition unit 155, for example, identifies user identifiers of other users corresponding to the group identifier, and acquires stay information corresponding to each user identifier from the user information storage unit 111. When the stay information of the user is also stored as group information or group feature information, the member information acquisition unit 155 may acquire the stay information from the group information or the group feature information corresponding to the group identifier. The member information acquisition unit 155 can acquire the member information using the stay information of each user.

Furthermore, the member information acquisition unit 155 may acquire state information of each member of the group, and acquire the member information using the acquired state information.

Furthermore, the member information may include information indicating chronological changes in the state of other users belonging to the group to which the destination user belongs. For example, the member information acquisition unit 155 may acquire past chronological position information, and member information that enables grasping the movement history of each user over a predetermined period of time may be acquired based thereon. The member information acquisition unit 155 may, for example, acquire member information that enables grasping which member is in which state and at which position, using the position information and the state information. The member information acquisition unit 155 may, for example, acquire member information including information indicating chronological changes in the state of other users, using the position information and the stay information. The information indicating chronological changes in the state of other users may be information indicating transition of state information, or information indicating a recording progress of stay information recorded as appropriate for other users.

Furthermore, the member information may be configured such that information regarding the user corresponding to the stay information is output to the destination user in an output mode corresponding to the stay information. For example, the member information acquisition unit 155 may be configured to identify the state of the user using the stay information, and to acquire the member information such that information regarding the user is output in an output mode corresponding to the identified state. The state of the user identified using the stay information may be, for example, having arrived at or not having arrived at a predetermined location, or staying at a specific location for a predetermined time or more, or being in transit.

The feature information output unit 161, when outputting the output information, outputs the output information using the group feature information acquired by the feature information acquisition unit 151. The output information is output in association with the destination user. Outputting the output information in association with a user means, for example, transmitting the output information to the terminal device 600 used by the user, but is not limited thereto. In the present embodiment, since the terminal device 600 outputs information based on the output information, the feature information output unit 161 may also be described as outputting the output information to the user using the terminal device 600 by transmitting the output information to the terminal device 600 used by the user. Outputting the output information in association with a user may be, for example, causing the storage unit 110 or the like to store the output information in association with the user identifier of the user, or transmitting the output information to another device. The output information is configured, for example, to be output in response when information requesting the output information is transmitted from the terminal device 600. The information requesting the output information may be transmitted, for example, when an instruction to change display content is given to the terminal device 600 by the user, but this is not limiting. For example, the output information may be output when a predetermined output condition is satisfied, such as when a predetermined time has arrived or an instruction from another user has been made.

The feature information output unit 161 may be configured to output the group feature information as the output information, or may be configured to output information based on the group feature information as the output information. The information based on the group feature information is, for example, information acquirable using information included in the group feature information, and may include information corresponding to a feature. That is, the output information may be described as information that can correspond to a feature on a map, that is, information that can be represented on a map. Specifically, the output information may be, for example, information identifying a feature recorded in the group, or may include various types of information regarding the map feature. Furthermore, it may include specific input information or the like input by the user.

In the present embodiment, the feature information output unit 161 is configured to acquire output information regarding a feature using the specific input information and the specific related information, and to output the output information in association with the destination user. As a result, the destination user can confirm the feature information of each feature input in accordance with the input rule defined within the group by the specific input information acceptance function.

The feature information output unit 161 may be configured to determine whether the group feature information acquired by the feature information acquisition unit 151 satisfies a predetermined feature condition, and to output the output information corresponding to the group feature information in an output mode corresponding to a determination result. The determination may be performed, for example, for each feature, but is not limited thereto. For example, the determination may be performed collectively for two or more features of a specific area, two or more features of a common type, or two or more features having a common attribute value of another attribute.

The predetermined feature condition is, for example, that the feature information has been input as specific input information, but this is not limiting. For example, composite conditions such as a predetermined deadline having elapsed and the feature being in a predetermined state may be set. The predetermined feature condition may be, for example, a condition determined using not only the feature information but also other information. For example, it may be determined based on the position information of the feature and the member information that the feature has not been visited by any member during a predetermined time period. That the feature information is of a predetermined type of information and that separately acquired current weather information is a predetermined weather may be used as the predetermined feature condition. Furthermore, it may be determined using processing information corresponding to the feature, acquired separately, that the processing information corresponding to the feature is in a predetermined state.

Outputting the output information in an output mode corresponding to the determination result means, for example, when display of information using the output information is performed by the terminal device 600, constructing the output information such that the display mode differs according to the determination result, and outputting the output information. That is, the feature information output unit 161 may be described as constructing the output information such that the display mode of information display performed by the terminal device 600 using the output information differs according to the determination result. The different display mode means, for example, that the size of characters, symbols, or figures differs, that the typeface, font weight, or the like differs, that the color, shade, or animation used for display differs, and the like, but is not limited thereto. When information using the output information is output by sound by the terminal device 600, the output information may be constructed such that the tone, sound effects, volume, pitch, and the like differ. The different output mode may be, for example, when two or more pieces of feature information are included in the output information, that the order in which each piece of feature information is output (the order defined in the output information) differs. Furthermore, the different output mode may be, for example, that the destination differs. When output of information using the output information is performed by the terminal device 600, constructing and outputting the output information such that the output method differs according to the determination result may be outputting the output information in an output mode corresponding to the determination result.

The feature information output unit 161 may be configured to acquire permission information of the destination user, and to output the output information in accordance with a determination result of whether the destination user satisfies a permission condition regarding the permission. The feature information output unit 161 may, for example, construct the output information by including feature information that the user can view or the like based on the permission condition in the output information, and not including feature information that the user cannot view or the like in the output information.

Furthermore, the feature information output unit 161 may be configured to determine whether each piece of feature information regarding each feature in the group feature information is associated with the destination user, and to output the output information in an output mode corresponding to the determination result. For example, for feature information associated with the destination user, the output information may be output such that the output mode differs from the output mode of the feature information for other users. As a result, the user can easily recognize the feature information associated with the user. Feature information being associated with a user means, for example, that the user has been assigned as a person in charge of performing an action on the feature information, but is not limited thereto. For example, it may mean that the user has been recorded as a person who has performed an action on the feature information, or that the user is the person who input the feature information.

Furthermore, when the processing rule information is acquired by the rule information acquisition unit 143 as described above, the feature information output unit 161 may be configured to acquire the output information using the specific input information input for each feature and the processing information regarding the map feature, based on the processing rule information. In this case, the feature information output unit 161 can acquire, for each feature, the processing information corresponding to the feature from the processing information providing device 702 using information identifying the feature. Then, the output information can be acquired using the specific input information and the processing information. For example, when a measurement value of a predetermined indicator for a feature is obtained as the specific input information, a calculated value to be included in the output information may be acquired using the measurement value together with the processing information. The effort of acquiring calculated values for each feature can be reduced, and output information including the calculated values can be easily utilized within the group.

In the present embodiment, the feature information output unit 161 may be configured to output the member information together with the output information in association with the destination user. As a result, the user can confirm the information that can correspond to features on a map together with the member information. When the member information includes position information of each user, information that enables easy recognition of the positional relationship between information corresponding to features on a map and the positions of members can be output. When the member information includes position information of each user, information of each user included in the member information may be grasped as feature information.

Furthermore, in the present embodiment, the feature information output unit 161 may be configured to be able to output output information based on time information that enables specification of the time at which each piece of feature information was recorded (which may include the time when it was input and the time when it was updated). This is achievable by the following configuration. That is, the feature information storage unit 113 stores time information that enables specification of the time at which the group feature information was recorded. The time information is, for example, stored in association with the group feature information. Furthermore, the feature information acquisition unit 151, when acquiring information corresponding to one group identifier from the feature information storage unit 113, acquires two or more sets of the group feature information corresponding to the group identifier and the time information corresponding to the group feature information. That is, normally, the feature information storage unit 113 stores a plurality of sets of the group feature information and the time information for each group. When the group feature information is acquired for any group, two or more sets of the stored group feature information and time information are acquired. When sets of the group feature information and the time information for one group are acquired, all sets stored in the feature information storage unit 113 in association with the group identifier of the group may be acquired, or only some of the sets may be acquired. Then, the feature information output unit 161 is configured to output the output information based on the information acquired by the feature information acquisition unit 151. The feature information output unit 161 acquires the output information using two or more sets of the acquired group feature information and the time information, and outputs the acquired output information. Here, the output information output by the feature information output unit 161 may include, for example, information for displaying two or more pieces of the group feature information or information based on the group feature information in reverse chronological order. By outputting such output information, for example, a timeline screen for displaying feature information in chronological order as described later can be displayed on the terminal device 600. The output information may be information used when construction of the timeline screen is performed by the terminal device 600, or may include an image or the like indicating the timeline screen. When outputting the output information for displaying such a timeline screen on the terminal device 600, the feature information output unit 161 may be configured to set a predetermined number of pieces of the group feature information or information based thereon from the latest group feature information at that time as display targets. Furthermore, the group feature information or information based thereon during a period designated by the user may be set as targets for chronological display. Furthermore, the group feature information or information based thereon that satisfies a predetermined condition regarding the type or other attribute values of the group feature information may be set as display targets. When the member information is output together with the output information, information such as position information of the user included in the member information may also be output as the member information in association with the time information at which it was recorded. In this case, the information such as position information of each user can also be included in the timeline screen and displayed in chronological order.

Furthermore, for example, the feature information output unit 161 may acquire feature information of a feature designated by a member or a feature identified using the group information or user information corresponding to the group identifier of the group, among the group feature information, and determine whether the feature information satisfies a predetermined attention condition. In this case, the feature information output unit 161 can construct the output information such that information regarding the map feature is output in an output mode corresponding to the determination result. Since the feature information of the feature designated by the member or the designated feature can be output in a mode corresponding to the determination result, information regarding features that should be noted within the group can be easily recognized by members.

The list output unit 165 outputs a member list including user identifiers of one or more other users associated with the group identifier corresponding to the user identifier of the destination user, such that the destination user can confirm the member list. The output of the member list is executed, for example, when a display request corresponding to the destination user is made, but may be periodically performed for the user to be output to. The display request may be configured, for example, to be made from the terminal device 600 in response to a predetermined operation by the user, but may be automatically made, for example, when it is determined that a predetermined state has been reached for the user.

In the present embodiment, the list output unit 165 performs a list construction process that constructs the member list in accordance with the state information corresponding to each of the user identifiers included in the member list. Then, the list output unit 165 is configured to output the member list constructed by the list construction process. The state information is, for example, information indicating whether the user is available to respond or the like, which can be acquired from the user information stored in the user information storage unit 111, but is not limited thereto. For example, the state information may be a distance calculated using the position information of the target user who performed the operation of outputting the member list and the position information of each user, or a distance from each user to a feature calculated using the position information of each user and the feature information of a specific feature. The list construction process includes, for example, a process of specifying the order of each user identifier in the member list by performing sorting from a predetermined viewpoint using the state information, but is not limited thereto. The list construction process may include a process of determining, for each user identifier, whether the state information satisfies a predetermined state condition, and determining whether to set the user identifier as a selectable target in the member list based on the determination result. The state condition may be, for example, that the user is in a communicable state, that the distance to the user is within a predetermined value, and the like, but is not limited thereto.

When such a member list is output, the target user can use the terminal device 600 to designate one or more members included in the member list as destinations (mention destinations) and perform a mention operation. The mention operation includes, for example, an operation of designating information to be transmitted. By the mention operation, the target user can transmit information to the destination. The information transmitted by the mention operation includes, for example, information regarding a feature, for example, a message, a photo, a video, and the like, but is not limited thereto. The operation of designating information to be transmitted may be, for example, an operation of designating a feature on a map, or an operation of inputting text to be transmitted or designating an image. The order of the operation of designating the destination and the operation of designating information to be transmitted within one acceptance of the mention operation does not matter. In the present embodiment, the target user can perform the operation of designating information to be transmitted based on the output information output by the feature information output unit 161.

The mention operation acceptance unit 166 accepts a predetermined mention operation performed by the user (target user) of the destination of the member list. The mention operation is an operation performed by the target user in association with one or more user identifiers of members included in the member list output by the list output unit 165.

The mention output unit 167 outputs, based on the acceptance result of the mention operation accepted by the mention operation acceptance unit 166, information corresponding to the mention operation, that is, information corresponding to the designation operation, in association with the user corresponding to the user identifier associated with the mention operation. That is, information designated by the mention operation is output to the mention destination member designated by the target user in the mention operation.

In the present embodiment, the mention destination member can recognize that the information designated by the mention operation is addressed to the member, by receiving the output information or the like using the terminal device 600. The mention destination member can recognize the information designated by the mention operation together with the output information output by the feature information output unit 161. Communication between two or more users within the group can be easily achieved using the information shared within the group. By enabling the information designated by the mention operation to be confirmed on the map, feature-related information sharing within the group can be performed more easily. A member different from the mention destination member may also be able to receive the information designated by the mention operation. In this case, it is preferable that the output mode of information to the mention destination member and the output mode of information to a member different from the mention destination member differ. For example, when the mention operation is performed, a so-called push notification may be sent to the mention destination member. Furthermore, by displaying the information designated by the mention operation on a list screen that enables listing of information transmitted to the member as a mention destination so far, the mention destination member may be able to easily recognize information addressed to the member by viewing the list screen.

In this way, the above-described mention function is realized by the list output unit 165, the mention operation acceptance unit 166, and the mention output unit 167.

The transmission unit 170 transmits information to other devices constituting the information processing system 1 via a network. The transmission unit 170 performs transmission of information to be output, for example, to the terminal device 600 and other devices.

The storage unit 110, the terminal storage unit 610, the map rendering information storage unit 711, and the processing information storage unit 712 described above are preferably non-volatile recording media, but may be realized by volatile recording media. Information and the like acquired in the respective devices are respectively stored therein, but the process by which information and the like are stored is not limited thereto. For example, information and the like may be stored via a recording medium, information and the like transmitted via a communication line may be stored, or information and the like input via an input device may be stored.

Furthermore, the processing unit 140 and the terminal processing unit 640 described above may typically be realized by an MPU, a memory, and the like. Processing procedures of the processing unit 140 and the terminal processing unit 640 are typically realized by software, and the software is recorded in a recording medium such as a ROM. However, they may be realized by hardware (a dedicated circuit).

Furthermore, input means that can be used for input of information acceptable by the acceptance unit 130 and the terminal acceptance unit 630 may be anything such as a ten-key pad, a keyboard, a mouse, or a menu screen. The acceptance unit 130 and the terminal acceptance unit 630 may be realized by a device driver of input means such as a ten-key pad or a keyboard, control software of a menu screen, and the like.

Furthermore, the reception unit 120 and the terminal reception unit 620 are typically realized by wireless or wired communication means, but may be realized by means for receiving broadcasts.

Furthermore, the transmission unit 170 and the terminal transmission unit 670 are typically realized by wireless or wired communication means, but may be realized by broadcasting means.

Next, an example of the operations of the information processing apparatus 100 and the terminal device 600 performed when the user uses the information processing system 1 according to the present embodiment will be described.

In the present embodiment, the user can, for example, access the information processing apparatus 100 using the terminal device 600, output and confirm the output information output from the information processing apparatus 100 using the terminal device 600, and transmit the position information and specific input information of the user to the information processing apparatus 100. As a result, the user can use each function realized by the information processing system 1.

When the information processing system 1 is used in this manner, the information processing apparatus 100 and the terminal device 600 perform various operations, for example, as follows. These operations are performed by the processing unit 140 and the terminal processing unit 640 executing control operations and the like using the respective units. Information such as processing results may be output to the terminal device 600 used by the user as appropriate in accordance with the operation of the information processing apparatus 100.

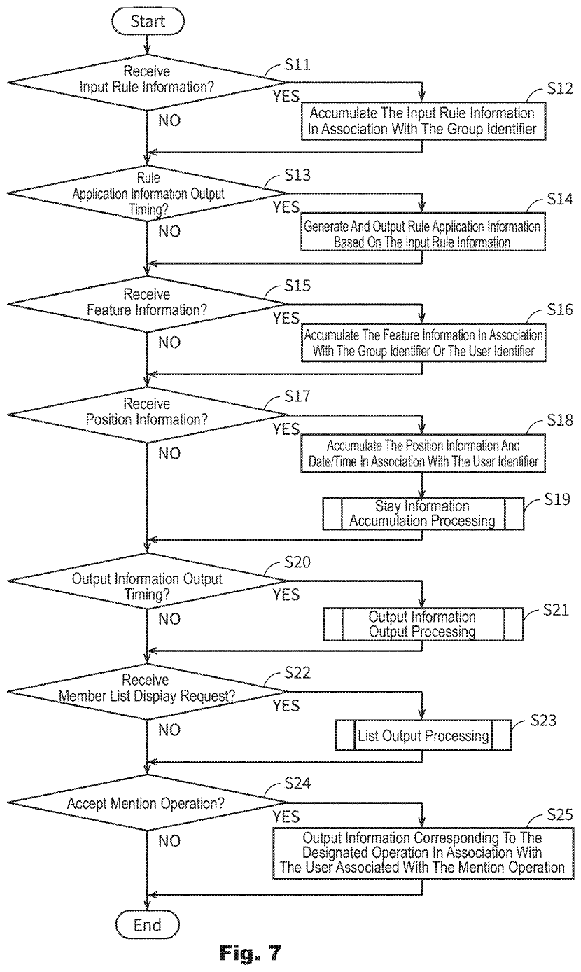

FIG. 7 is a flowchart showing an example of an operation of the information processing apparatus 100.

The following process is, for example, repeatedly executed at predetermined time intervals. The process may be started each time when the processing unit 140 determines that a predetermined start condition has been satisfied.

(Step S11) The processing unit 140 determines whether input rule information has been received. When it is determined that input rule information has been received, the process proceeds to step S12. Otherwise, the process proceeds to step S13.

(Step S12) The processing unit 140 accumulates the input rule information in association with the group identifier. The processing unit 140 may accumulate acceptance rule information in association with the input rule information.

(Step S13) The processing unit 140 determines whether the output timing for the rule application information has arrived. When it is determined that the output timing has arrived, the process proceeds to step S14. Otherwise, the process proceeds to step S15.

(Step S14) The processing unit 140 constructs rule application information based on the input rule information corresponding to the group identifier, and outputs the rule application information to a user corresponding to the group identifier.

(Step S15) The processing unit 140 determines whether feature information has been received. When it is determined that feature information has been received, the process proceeds to step S16. Otherwise, the process proceeds to step S17.

(Step S16) The processing unit 140 accumulates the accepted feature information in association with the group identifier or the user identifier.

(Step S17) The processing unit 140 determines whether position information has been received. When it is determined that position information has been received, the process proceeds to step S18. Otherwise, the process proceeds to step S20.

(Step S18) The processing unit 140 accumulates the position information and the date and time in association with the user identifier.

(Step S19) The processing unit 140 performs a stay information accumulation process.

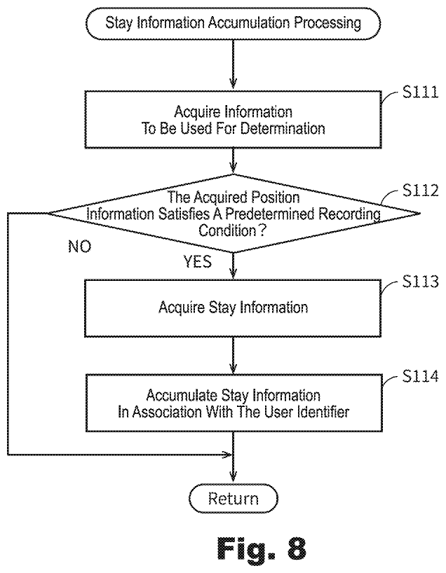

FIG. 8 is a flowchart showing an example of the stay information accumulation process performed by the information processing apparatus 100.

(Step S111) The processing unit 140 acquires information for use in the determination. For example, when the predetermined recording condition is related to the movement distance or the staying time, past position information and the like are acquired.

(Step S112) The processing unit 140 determines whether the acquired position information satisfies the predetermined recording condition. When it is determined that the predetermined recording condition is satisfied, the process proceeds to step S113. Otherwise, the stay information accumulation process is terminated.

(Step S113) The processing unit 140 acquires stay information.

(Step S114) The processing unit 140 accumulates the stay information in association with the user identifier. Thereafter, the process returns to the higher-level process.

(Step S20) Returning to FIG. 7, the processing unit 140 determines whether the output information output timing has arrived. When it is determined that the output information output timing has arrived, the process proceeds to step S21. Otherwise, the process proceeds to step S22.

(Step S21) The processing unit 140 performs an output information output process.

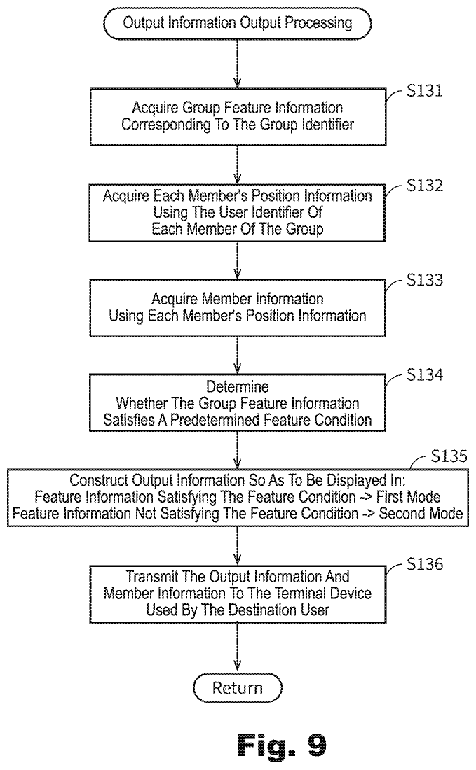

FIG. 9 is a flowchart showing an example of the output information output process performed by the information processing apparatus 100.

(Step S131) The processing unit 140 acquires group feature information corresponding to the group identifier.

(Step S132) The processing unit 140 acquires position information of each member using the user identifiers of the members of the group.

(Step S133) The processing unit 140 acquires member information using the position information of each member. Stay information or state information corresponding to each member may be used to acquire the member information.

(Step S134) The processing unit 140 determines whether the group feature information satisfies a predetermined feature condition.

(Step S135) The processing unit 140 constructs the output information such that feature information determined to satisfy the feature condition is displayed in a first mode, and feature information determined not to satisfy the feature condition is displayed in a second mode.

(Step S136) The processing unit 140 transmits the output information and the member information to the terminal device used by the destination user. Thereafter, the process returns to the higher-level process.

(Step S22) Returning to FIG. 7, the processing unit 140 determines whether there has been a display request for a member list. When it is determined that there has been a display request for a member list, the process proceeds to step S23. Otherwise, the process proceeds to step S24.

(Step S23) The processing unit 140 performs a list output process.

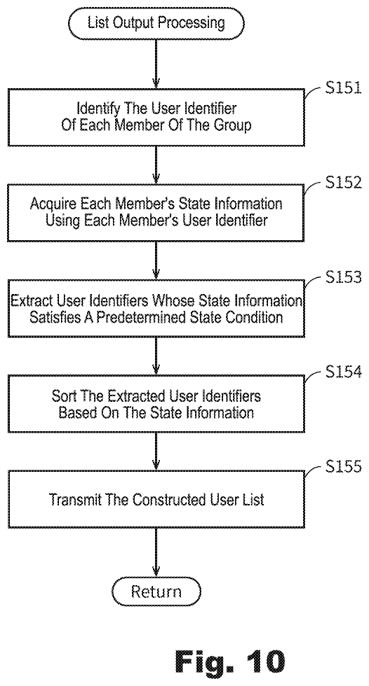

FIG. 10 is a flowchart showing an example of the list output process performed by the information processing apparatus 100.

(Step S151) The processing unit 140 identifies the user identifiers of the members of the group.

(Step S152) The processing unit 140 acquires the state information of each member using the user identifiers of each member.

(Step S153) The processing unit 140 extracts user identifiers whose state information satisfies a predetermined state condition.

(Step S154) The processing unit 140 sorts the extracted user identifiers based on the state information.

(Step S155) The processing unit 140 transmits the constructed user list. Thereafter, the process returns to the higher-level process.

(Step S24) Returning to FIG. 7, the processing unit 140 determines whether a mention operation has been accepted. When it is determined that a mention operation has been accepted, the process proceeds to step S25. Otherwise, the series of operations is terminated.

(Step S25) The processing unit 140 outputs information corresponding to the designation operation in association with the user corresponding to the user identifier associated with the mention operation.

When the processing of step S25 is completed, the series of operations is terminated.

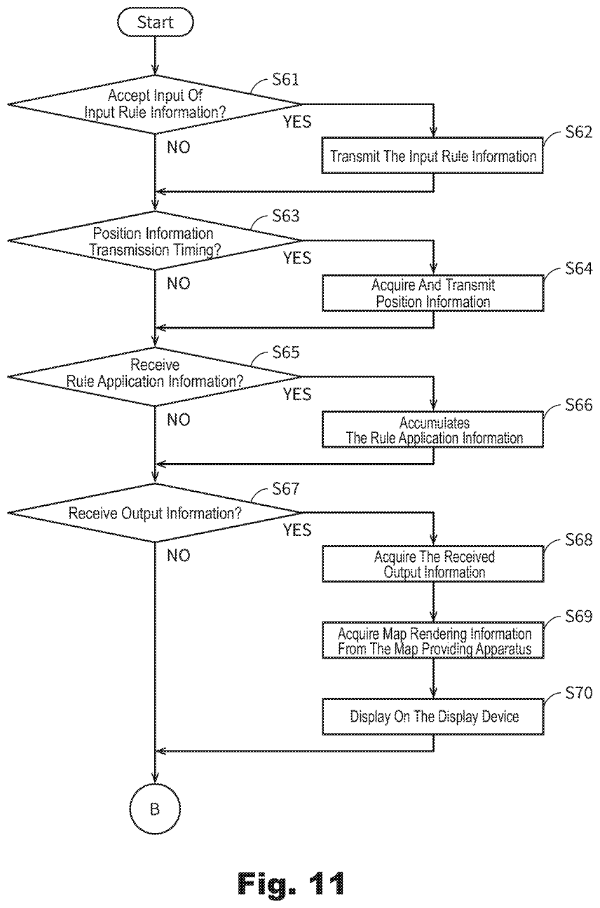

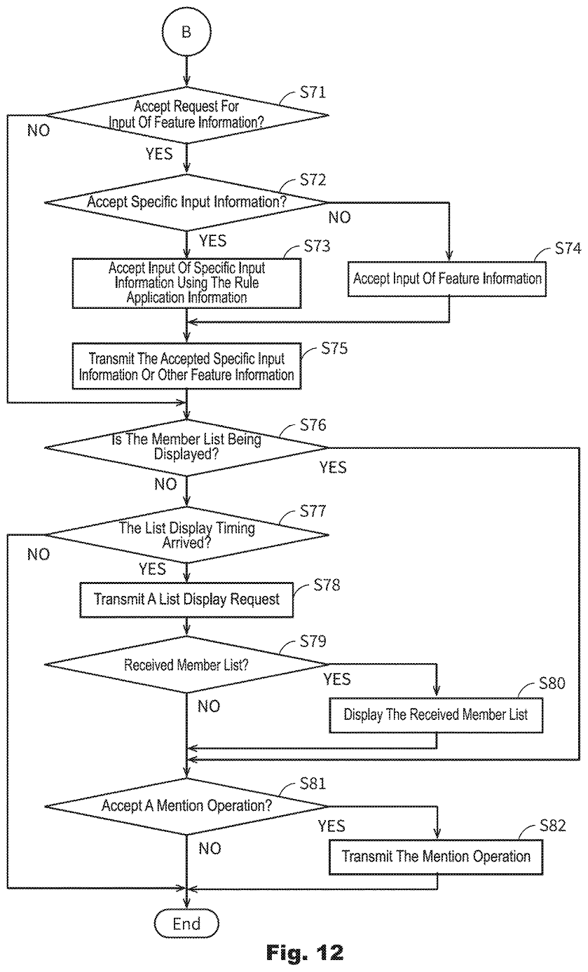

FIG. 11 is a first flowchart showing an example of an operation of the terminal device 600. FIG. 12 is a second flowchart showing an example of an operation of the terminal device 600.

The following process is, for example, repeatedly executed at predetermined time intervals. The process may be started each time when the terminal processing unit 640 determines that a predetermined start condition has been satisfied.

(Step S61) The terminal processing unit 640 determines whether input of input rule information by the user has been accepted. When it is determined that input of input rule information has been accepted, the process proceeds to step S62. Otherwise, the process proceeds to step S63.

(Step S62) The terminal processing unit 640 transmits the input rule information.

(Step S63) The terminal processing unit 640 determines whether the position information transmission timing has arrived. When it is determined that the position information transmission timing has arrived, the process proceeds to step S64. Otherwise, the process proceeds to step S65.

(Step S64) The terminal processing unit 640 acquires and transmits the position information.

(Step S65) The terminal processing unit 640 determines whether rule application information has been received. When it is determined that the rule application information has been received, the process proceeds to step S66. Otherwise, the process proceeds to step S67.

(Step S66) The terminal processing unit 640 accumulates the rule application information.

(Step S67) The terminal processing unit 640 determines whether output information has been received. When it is determined that output information has been received, the process proceeds to step S68. Otherwise, the process proceeds to step S69.

(Step S68) The terminal processing unit 640 acquires the received output information.

(Step S69) The terminal processing unit 640 acquires map rendering information from the map providing device.

(Step S70) The terminal processing unit 640 displays on the display device.

(Step S71) The terminal processing unit 640 determines whether there is an input request for feature information by the user. When it is determined that there is an input request, the process proceeds to step S72. Otherwise, the process proceeds to step S76.

(Step S72) The terminal processing unit 640 determines whether to accept specific input information. When it is determined to accept specific input information, the process proceeds to step S73. Otherwise, the process proceeds to step S74. For example, when the rule application information corresponding to the feature corresponding to the feature information input request has been received, it can be determined to accept specific input information. As an example, when the rule application information, that is, the input rule information, is associated with a specific type of feature, and an input request regarding a feature corresponding to the type is made, the feature and the rule application information can be described as corresponding.

(Step S73) The terminal processing unit 640 accepts input of specific input information using the rule application information. Thereafter, the process proceeds to step S75.

(Step S74) The terminal processing unit 640 accepts input of feature information. Thereafter, the process proceeds to step S75.

(Step S75) The terminal processing unit 640 transmits the accepted specific input information or other feature information.

(Step S76) The terminal processing unit 640 determines whether the member list is being displayed. When it is determined that the member list is being displayed, the process proceeds to step S81. Otherwise, the process proceeds to step S77.

(Step S77) The terminal processing unit 640 determines whether the list display timing has arrived, that is, whether an operation to make a display request has been accepted. When it is determined that the list display timing has arrived, the process proceeds to step S78. Otherwise, the series of operations is terminated.

(Step S78) The terminal processing unit 640 transmits a list display request.

(Step S79) The terminal processing unit 640 determines whether a member list has been received. When it is determined that a member list has been received, the process proceeds to step S80. Otherwise, the terminal processing unit 640 waits until the member list is received.

(Step S80) The terminal processing unit 640 displays the received member list.

(Step S81) The terminal processing unit 640 determines whether a mention operation by the user has been accepted. When it is determined that a mention operation has been accepted, the process proceeds to step S82. Otherwise, the series of operations is terminated.

(Step S82) The terminal processing unit 640 transmits the accepted mention operation. As a result, information is transmitted to the designated user by the information processing apparatus 100.

When the processing of step S82 is completed, the series of operations is terminated.

In the present embodiment, a screen of an application for using the information processing apparatus 100 is displayed on the display device 662 of the terminal device 600 of the user, and display (output) of information to the user and acceptance of information input operations by the user are performed. That is, the user can use the information processing apparatus 100 while causing various screens to be displayed on the terminal device 600. Screen transitions are realized by the terminal device 600 and the information processing apparatus 100 communicating as appropriate, and by the terminal processing unit 640 of the terminal device 600 and the processing unit 140 performing control operations in accordance with operations of the user accepted by the terminal acceptance unit 630, and the like. This is performed, for example, using information that can be handled by a predetermined application such as a predetermined client application operating on the terminal device 600. Information stored in the terminal device 600 and information transmitted from a device such as the information processing apparatus 100 can be used. The information processing apparatus 100 may provide web pages that can be displayed on the terminal device 600, thereby enabling the terminal device 600 to display information. Hereinafter, specific examples of representative display screens will be described.

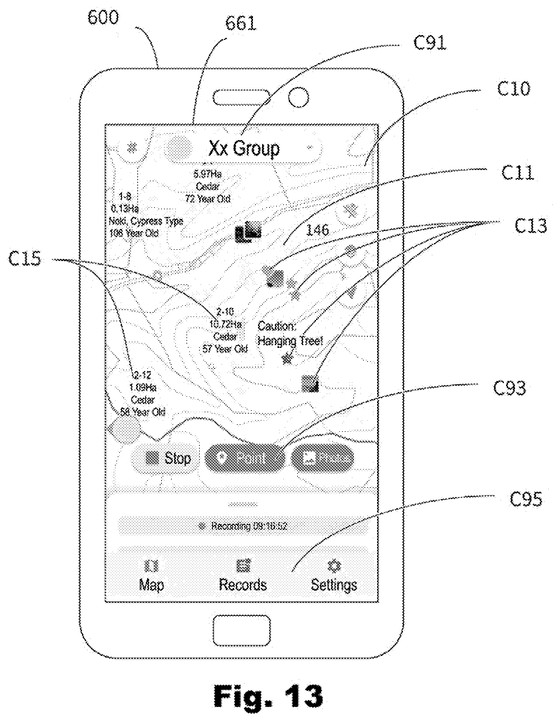

FIG. 13 is a diagram illustrating one specific example of a map display screen C10 of an application operating on the terminal device 600.

In FIG. 13, an example of a state in which the map display screen C10 is displayed on the display device 662 of the terminal device 600 of the user is shown. Such a screen is displayed using, for example, information such as output information transmitted from the information processing apparatus 100, map rendering information acquired from the map providing device 701, and the like. Except for the output information transmitted from the information processing apparatus 100, the source of information used for displaying the screen and the method of displaying the screen are not limited thereto, and can be configured as appropriate. The user can use the feature information sharing function by transmitting a predetermined user identifier or the like to the information processing apparatus 100 and logging in to a web service providing the feature information sharing function.

The map display screen C10 is a screen that enables the user to confirm information based on the output information together with the map. The map display screen C10 is a screen used for enabling use of various functions for transmitting individual information and the like to the information processing apparatus 100 and making various instructions and requests. In the example shown in the figure, the map display screen C10 displays a plurality of types of information in separate layers hierarchically. The user can select whether to display each layer, thereby making it easier to see the information the user wishes to confirm.

In the example shown in the figure, the map display screen C10 includes, for example, a group feature marker C13 that is a marker indicating the position of a feature on a map C11, and a specific input information display C15 that is information based on the specific input information and the specific related information.

The group feature marker C13 indicates the position of a feature for which feature information has been accepted from a member, so that it becomes a sharing target within the group. Images (icons) and the like displayed as markers differ according to the feature information. Furthermore, in the example shown in the figure, a thumbnail image of a photo captured by a member and accepted as feature information is displayed as the group feature marker C13. When an operation of selecting the group feature marker C13 is performed by the user, for example, a display indicating the content of feature information regarding the corresponding feature is made, and the user can confirm the content. Furthermore, by performing an operation of designating the group feature marker C13 in the above-described mention operation, the feature information can be output to the mention destination user.

The specific input information display C15 displays, for example, the content of specific input information and specific related information that have already been accepted, at a location on the map C11 indicating the position of the feature targeted for evaluation. In the example shown in the figure, the display is in text information, but the presence of the information may be indicated by a marker or the like similarly to the group feature marker C13. By the specific input information display C15, members can intuitively grasp the specific input information and the like on the map C11.

In the example shown in the figure, the map display screen C10 includes operation images such as a group information button C91, a feature information input button C93, and an information switching menu C95. The user can use various specific functions by performing an operation such as designating these operation images.

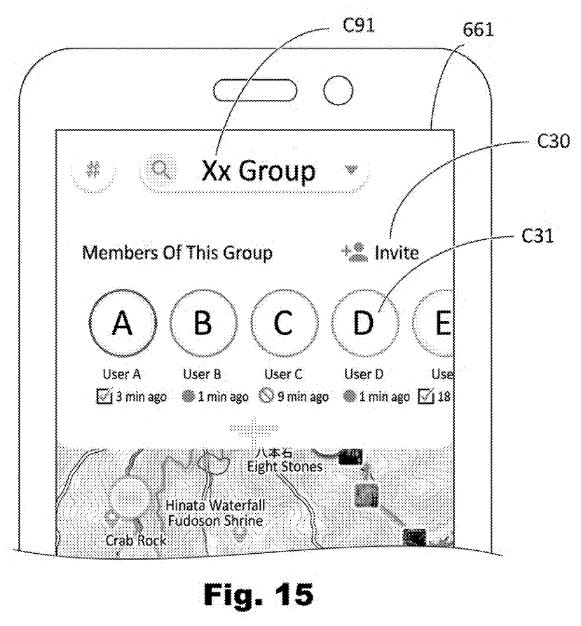

The group information button C91 is a button for causing a group information display screen C30 (shown in FIG. 15) including information regarding the group to be displayed. The group information display screen C30 is a screen that includes information regarding the group and is configured to enable input of operations and the like regarding the group. Details will be described later.

The feature information input button C93 is a button that the user operates when inputting feature information. In the example shown in the figure, the feature information input button C93 includes, for example, buttons for “trajectory,” “point,” and “photo.” By operating these, the user can perform recording of feature information indicating a travel route (movement trajectory) passing through the current point, input of information about the feature at the current position, and recording of a photo of the feature at the current position, respectively. When inputting information about a feature, characters input by the user, tags to be tagged, and the like are accepted, but this is not limiting. When an operation of inputting information about a feature targeted for input of specific input information is performed, information such as options of attribute values acceptable as specific input information is displayed based on the rule application information, so that the user can easily input the specific input information.

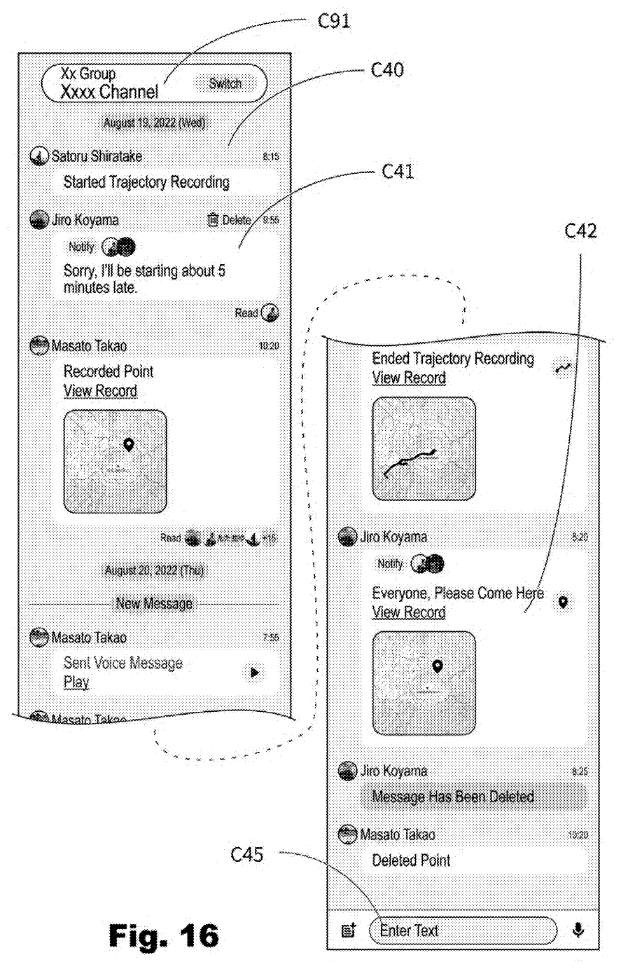

The information switching menu C95 includes buttons for designating whether to display the map display screen C10, a list screen for listing information based on the output information, that is, feature information input by the group, or a settings screen. The user can display a desired screen and perform confirmation or input of information, change settings operations, and the like by operating these buttons. In the present embodiment, as the list screen, for example, a timeline screen C40 (shown in FIG. 16) indicating information input by users and information recorded in the group in chronological order is displayed. Details of the timeline screen C40 will be described later.

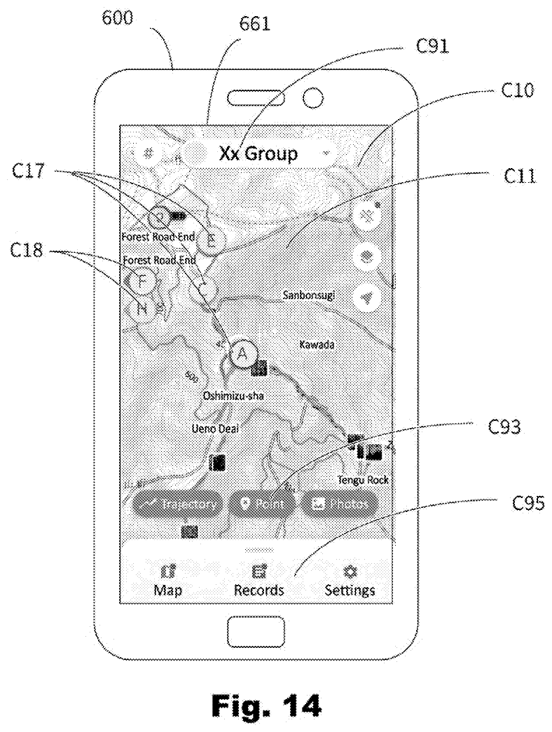

FIG. 14 is a diagram illustrating another specific example of the map display screen C10 of an application operating on the terminal device 600.

In FIG. 14, an example of the map display screen C10 with modified display content is shown. That is, in the example shown in the figure, the map display screen C10 shows user position markers C17, C18 indicating the positions of members. The user position markers C17, C18 are displayed based on the member information. The user position markers C17, C18 are images displayed at positions on the map C11 corresponding to the position information of each member. As the user position markers C17, C18, images set by each user as their own icon images may be displayed, but this is not limiting. Since the user position markers C17, C18 are displayed on the map, the user can easily grasp the position of each user. The display mode of the user position markers C17, C18 may correspond to the state of each user.

In the example shown in the figure, for users positioned within the range of the displayed map C11, the user position markers C17 are displayed at their positions. On the other hand, for users positioned outside the range of the displayed map C11, the user position markers C18 are displayed with arrows so that it is apparent that the users are outside the range. The user position markers C18 are displayed at a position near the edge of the displayed map C11 closest to the user's position. As a result, the existence of members who are far from the displayed location and the direction of their positions can be easily grasped.

Such user position markers C17, C18 are displayed on the map display screen C10 while each user allows their position information to be trackable by members. For example, when a user records feature information indicating a travel route using the feature information input button C93, the user can share the user's own position with other members.

FIG. 15 is a diagram illustrating one specific example of a group information display screen C30 of an application operating on the terminal device 600.

In FIG. 15, the group information display screen C30 displayed in a part of the display device 662 when the group information button C91 is operated on the map display screen C10 shown in, for example, FIG. 14, is shown. In the example shown in the figure, the group information display screen C30 includes a member list C31 indicating the state of each member of the group. The member list C31 includes, for example, for each member, an icon image, a state display indicating whether the member is in a responsive (active) state, and a confirmation time display indicating the update timing of the latest position information. The state display may be performed by various methods, and may be performed by, for example, figures, symbols, and the like. For example, a no-parking mark indicating a state of not wanting to be spoken to, a check mark indicating completion of a task, a red circle flashing mark indicating an emergency, and other figures, icons, and the like may be used. Furthermore, the confirmation time display is displayed as information indicating how much time has elapsed since the position information was updated, but this is not limiting. The user can easily grasp the state of each member by confirming the member list C31.

Here, the user can easily perform a mention operation by performing an operation of selecting the icon image of each member displayed in the member list C31. That is, by selecting an icon image, the user can designate the member as a mention destination, and further perform an operation of designating information to be output. As a result, the user can intuitively perform a mention operation.

FIG. 16 is a diagram illustrating one specific example of a timeline screen C40 of an application operating on the terminal device 600.

In FIG. 16, the timeline screen C40 displayed in a part of the display device 662 when the information switching menu C95 is operated to display a list screen on the map display screen C10 shown in, for example, FIG. 13, is shown. On the timeline screen C40, target information input by each member of the group is displayed in chronological order. For example, feature information and information output by the mention operation are included in the target information. The target information is not limited thereto, and predetermined types of information regarding the actions and states of each member may be displayed. Furthermore, the user may be able to perform an operation of designating attributes and the like of information to be targeted in the timeline screen C40. By displaying such a timeline screen C40, the user can efficiently grasp events within the group. Information addressed to the user, or other notification information, may be displayed in a display mode different from others on the timeline screen C40.

Furthermore, the timeline screen C40 includes an input acceptance unit C45. The user can input information by designating the input acceptance unit C45, inputting information to be transmitted, and performing an operation of completing the input (an operation of transmitting). The input information is treated as, for example, user-input feature information in the information processing apparatus 100, and may be displayed on the timeline screen C40.

In the example shown in the figure, as information that may be included in the timeline screen C40, mention information (information output by the mention operation) C41, C42 in which a member has designated another member and input communication content or position information is shown. The mention information C41 includes information indicating the addressee designated by the mention operation and a message. The mention information C42 includes information indicating the addressee designated by the mention operation and input text such as “Everyone, please come here” input along with designation of position information. Furthermore, as other information that may be included in the timeline screen C40, for example, the following information is shown: that a member has started recording of the member's position information (started recording of a trajectory) or terminated it; communication content input by a member without designating another member; and information indicating that a member has input feature information.

Feature information of the group may be displayed in a listable manner. For example, when the information switching menu C95 is operated to display a list screen on the map display screen C10, feature information acquired as the group feature information of the group may be displayed in a list. Furthermore, an aggregated list screen C50 that shows such a list screen in an aggregated manner from a predetermined viewpoint may be displayable.

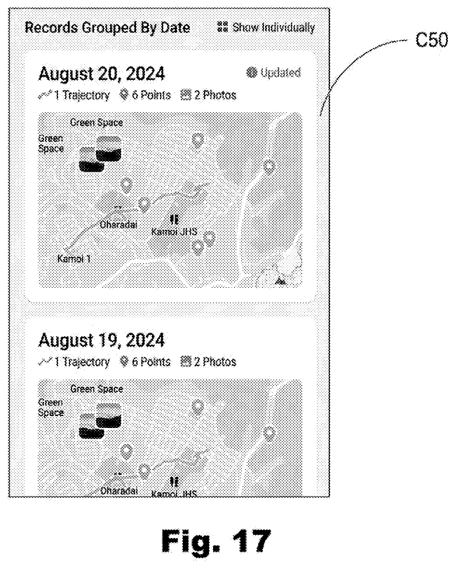

FIG. 17 is a diagram illustrating one specific example of an aggregated list screen C50 of an application operating on the terminal device 600.

The aggregated list screen C50 is, for example, a screen that aggregates and shows feature information input within the group on a per-day basis. In the example shown in the figure, the aggregated list screen C50 includes summary images that visually display the feature information corresponding to each day on a map. The unit for aggregating information is not limited thereto. The information may be aggregated on a time period, weekly, monthly, or yearly basis. Furthermore, the information may be aggregated on a per-member basis or on a per-type or per-nature basis of the feature information. By such an aggregated list screen C50, the user can more efficiently grasp events within the group. Since summary images are displayed, the user can grasp the information more easily.

By performing a detail display operation on the aggregated list screen C50, each piece of information included in the aggregated information may be confirmable.

The map display screen C10, the timeline screen C40, and the aggregated list screen C50 are each configured to be capable of displaying content of information according to an information display range designated by the user. That is, when the user designates the entire group as the information display range or designates a subgroup within the group as the information display range, only information regarding the corresponding group or subgroup can be displayed. The information display range may be designated by, for example, operating a specific part of the group information button C91, but may be designated by another method.

As described above, according to the present embodiment, feature information such as data regarding a map feature or data associated with a map feature can be shared and managed among members belonging to a group. A plurality of users can share with one another, within the group, information regarding points, map features, tracks, lines, and areas relating to activities, as well as comments, photographs, moving images, and the like linked to points. Since feature information to which attention should be paid in the group can be appropriately specified for each group and used within the group, information regarding a map feature to which attention should be paid can be easily shared. As the feature information, current positions of members, tracks, images, information of each point, and the like can be handled, and therefore the information processing system 1 can be used for various purposes in the group.

Specifically, the information processing system 1 can be used in, for example, the following situations and can realize easy execution of work. The following specific use cases are merely examples, and the uses of the information processing system 1 are not limited thereto.

For example, in the transportation industry such as construction logistics and fruit and vegetable logistics, the following applies. Travel routes and no-parking information can be placed on a map, and photographs taken can be incorporated into the map and used as evidence of completion of work. By sharing positions of transportation means such as trucks with customers, customers can easily grasp the transportation status. By having managers, respective drivers, customers, and the like as members of the same group, work can be easily carried out and services can be easily provided.

For example, in a group that performs facility management for infrastructure such as electric power, the following applies. In relevant art, there have been various problems such as cumbersome work for sharing site photographs and associating them with places, maps indicating locations of facilities and access routes being managed on paper, and separate tools or methods having to be used even when a tool for viewing a map, a tool for grasping worker positions, and a tool for sharing site information are available. By contrast, by using the information processing system 1, various types of information such as locations of facilities, work sites, work ranges, and access routes can be represented on a map in the terminal device 600 and shared within the group. Information of respective points before reaching an investigation report and photographs and the like can also be shared among members of the group. Therefore, even if members are replaced, target points can be easily accessed and completion records of work and the like can be confirmed. Further, since a current position or a past position of another member can be easily grasped, collaborative work among members becomes easier.

For example, in a situation in which an inspection or investigation relating to land use or the like by a public agency is carried out, the following applies. There is a problem in that field confirmation work required for inspection of subsidies, such as subsidies for replanting fruit trees and subsidies for utilization of paddy fields, is very cumbersome. In addition, for example, investigation of fixed asset tax has generally been performed by visually checking a site on the basis of a cadastral map and recording the result on a map or the like with a pencil, which has been inefficient because extra labor is separately required to use the recorded information and the like. By contrast, by using the information processing system 1, information such as paddy field ledgers and cadastral maps can be used as map rendering information, and photographs taken on site can be collectively incorporated on the map and shared among members of the group, so that information indicating investigation results and the like can be recorded in an easily usable state while dividing the work.

For example, in the forestry field, the following applies. In relevant art, in order to use a map electronically, it has been necessary to introduce a specially configured system or the like. By contrast, by using the information processing system 1, existing information such as contour lines, forest compartments, forest planning maps, and forest registers suitable for forestry is used as map rendering information, and feature information used by a group is input, whereby information usable for work can be easily and inexpensively shared within the group. Since work can be advanced while sharing, within the group, member information and results of input relating to feature information, work can be carried out more efficiently.

For example, in the agricultural field, the following applies. In a group led by a farm owner or in an association or the like, it has been difficult to report and grasp a status of each field, such as information regarding what work is being performed in which field. When harmful insects or diseases occur, it is necessary for the group to quickly grasp and deal with the occurrence, but it is difficult to share information in such a case. By contrast, by using the information processing system 1, information indicating divisions of respective fields is used as feature information or map rendering information, and results of work and occurrences at respective places are further recordable in association with positions by photographs and the like, whereby it becomes easy to collect and grasp these pieces of information within the group.

For example, in a group carrying out disaster response work, the following applies. In such a group, exchanges between each site and headquarters are generally performed by sending and receiving images and other information using electronic mail, facsimile, and the like, and it has been difficult to quickly grasp disaster damage status of roads, rivers, and other infrastructure and to efficiently manage response status. By contrast, by using the information processing system 1 and using information such as sediment disaster warning areas and hazard maps held by municipalities and the like as feature information or map rendering information, each member of the group goes to his or her assigned place and records the status, photographs taken, and the like, so that headquarters can grasp the information in real time. Communication mistakes are less likely to occur, and rapid determination of countermeasures and efficient issuance of necessary instructions can be carried out.

For example, in large-scale events held over a wide area, such as marathons, triathlons, trekking, bicycle races, and car rallies, the following applies. In a group managing such an event, various members including volunteers and the like are involved on the day of the event, and mutual information coordination has generally been performed by conventional voice calls, text messaging services, and the like, making it difficult to efficiently report statuses and issue necessary instructions. By contrast, by using the information processing system 1 and sharing, within the group, information such as event routes, points, and first-aid headquarters as feature information, and then recording instructions and information among members, current information can be easily shared and mutual communication can be carried out. For example, in a marathon event, positions of the leading vicinity, the rearmost vicinity, team leaders for respective roles, moving AEDs, and the like can be shared in real time within the group, so that each member can efficiently take necessary actions.

For example, in guide services such as ski guides, the following applies. In the information processing system 1, by using map rendering information such as contour lines and vegetation maps and feature information such as lift maps and boundary lines of ski resorts, information necessary for risk management and safety management can easily be shared with members and the like who are subjects of the guide. Even when visibility is difficult to secure due to weather or the like, situations of the respective members can be easily confirmed by using shared position information of the members.

In the present embodiment, the information processing apparatus 100 may also be said to perform the following information processing method. The information processing method is performed using a storage unit storing group feature information, the group feature information being associated with a group identifier corresponding to two or more user identifiers and being feature information regarding a map feature and being feature information recorded in advance based on a state or behavior of a user, a feature information acquisition unit, and a feature information output unit, and includes: a feature information acquisition step in which the feature information acquisition unit acquires, from the storage unit, the group feature information corresponding to a group identifier corresponding to the user identifier of a destination user by using the user identifier; and a feature information output step in which the feature information output unit outputs, in association with the destination user, the acquired group feature information or information based on the group feature information as output information.

In the present embodiment, the terminal device 600 may also be said to perform, together with the information processing apparatus 100, the following information processing method. Specifically, the information processing method is further performed using a map rendering information storage unit in which map rendering information indicating a map is stored, an output device, a terminal acquisition unit, and a terminal output unit, and includes: a map rendering information acquisition step in which the terminal acquisition unit acquires the map rendering information from the map rendering information storage unit; an output information acquisition step in which the terminal acquisition unit acquires output information output by the feature information output unit; and a terminal output step in which the terminal output unit displays, on the output device, information based on the output information on the map by using the map rendering information and the output information.

Processing in the present embodiment may also be realized by software. The software may be distributed by software download or the like. The software may also be distributed by recording the software on a recording medium such as an optical disk.

The software for realizing the information processing apparatus in the present embodiment is the following program. Specifically, the program causes a computer capable of accessing a storage unit in which group feature information is stored, the group feature information being associated with a group identifier corresponding to two or more user identifiers and being feature information regarding a map feature and being feature information recorded in advance based on a state or behavior of a user, to function as: a feature information acquisition unit that acquires, from the storage unit, the group feature information corresponding to a group identifier corresponding to the user identifier of a destination user by using the user identifier; and a feature information output unit that outputs, in association with the destination user, the acquired group feature information or information based on the group feature information as output information.

The software for realizing the terminal device in the present embodiment is the following program. This program causes a computer of a terminal device that is capable of accessing a map rendering information storage unit in which map rendering information indicating a map is stored and that includes an output device to function as: a map rendering information acquisition unit that acquires the map rendering information; an output information acquisition unit that acquires output information output from the information processing apparatus; and a terminal output unit that displays, on a display device, information based on the output information on the map by using the map rendering information and the output information.

### Others

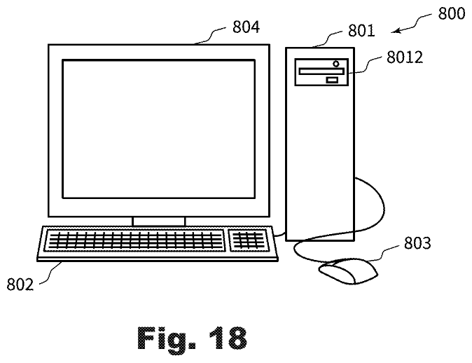

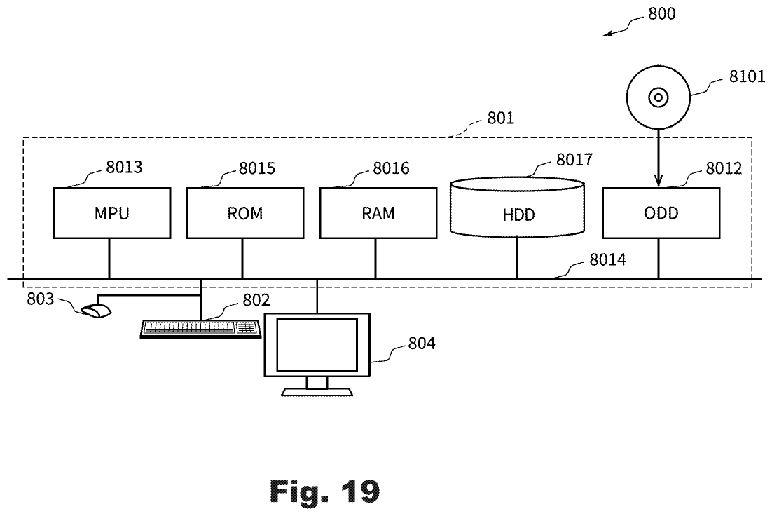

FIG. 18 is an overview diagram of a computer system 800 in the above embodiment. FIG. 19 is a block diagram of the computer system 800.

In these figures, an example of the configuration of a computer that executes the program described in the present specification to realize the information processing apparatus and the like of the above-described embodiment is shown. The above-described embodiment can be realized by computer hardware and a computer program executed thereon.

The computer system 800 includes a computer 801 including an optical disk drive, a keyboard 802, a mouse 803, and a monitor 804.

The computer 801 includes, in addition to an optical disk drive (ODD) 8012, an MPU 8013, a bus 8014 connected to the optical disk drive 8012 and the like, a ROM 8015 for storing programs such as a boot-up program, a RAM 8016 connected to the MPU 8013 for temporarily storing instructions of application programs and providing a temporary storage space, and a hard disk (HDD) 8017 for storing application programs, system programs, and data. Although not shown here, the computer 801 may further include a network card that provides connection to a LAN.

A program that causes the computer system 800 to execute the functions of the information processing apparatus and the like of the above-described embodiment may be stored in an optical disk 8101, inserted into the optical disk drive 8012, and further transferred to the hard disk 8017. Alternatively, the program may be transmitted to the computer 801 via a network (not shown) and stored in the hard disk 8017. The program is loaded into the RAM 8016 at the time of execution. The program may be directly loaded from the optical disk 8101 or the network.

The program does not necessarily need to include an operating system (OS) or third-party programs and the like that cause the computer 801 to execute the functions of the information processing apparatus and the like of the above-described embodiment. The program only needs to include the portion of instructions that calls appropriate functions (modules) in a controlled manner to obtain desired results. How the computer system 800 operates is well known, and detailed description is omitted.

In the above program, processing performed by hardware, for example, processing performed by a modem or an interface card in the transmission step (hardware-only processing), is not included in a transmission step of transmitting information, a reception step of receiving information, and the like.

Furthermore, the computer that executes the above program may be singular or plural. That is, centralized processing may be performed, or distributed processing may be performed.

Furthermore, in the above embodiment, two or more constituent elements existing in one device may be physically realized by one medium.

In the above embodiment, each constituent element may be constituted by dedicated hardware, or, for constituent elements realizable by software, may be realized by executing a program. For example, each constituent element can be realized by a program execution unit such as a CPU reading out and executing a software program recorded in a recording medium such as a hard disk or a semiconductor memory. At that time, the program execution unit may execute the program while accessing the storage unit or a recording medium. Furthermore, the program may be executed by being downloaded from a server or the like, or may be executed by being read from a predetermined recording medium (e.g., an optical disk, a magnetic disk, a semiconductor memory, or the like). Furthermore, this program may be used as a program constituting a program product. Furthermore, the computer that executes the program may be singular or plural. That is, centralized processing may be performed, or distributed processing may be performed.

Furthermore, in the above embodiment, each process (each function) may be realized by centralized processing by a single device (system), or may be realized by distributed processing by a plurality of devices (in this case, the entire system composed of the plurality of devices performing distributed processing can be grasped as one “apparatus”).

Furthermore, in the above embodiment, passing of information performed between respective constituent elements may be performed, for example, when the two constituent elements that pass information are physically different, by output of information by one constituent element and acceptance of information by the other constituent element, or when the two constituent elements that pass information are physically the same, by transitioning from the phase of processing corresponding to one constituent element to the phase of processing corresponding to the other constituent element.

Furthermore, in the above embodiment, information related to processing executed by each constituent element, for example, information that each constituent element has accepted, acquired, selected, generated, transmitted, or received, and information such as threshold values, formulas, addresses, and the like used by each constituent element in processing, may be temporarily or permanently held in a recording medium (not shown) even if not explicitly stated in the above description. Furthermore, accumulation of information in the recording medium (not shown) may be performed by each constituent element or by an accumulation unit (not shown). Furthermore, reading of information from the recording medium (not shown) may be performed by each constituent element or by a reading unit (not shown).

Furthermore, in the above embodiment, when information used by each constituent element and the like, for example, information such as threshold values, addresses, and various setting values used by each constituent element in processing, may be changed by the user, the user may be allowed to change the information as appropriate even if not explicitly stated in the above description, or may not be. When the information is changeable by the user, the change may be realized by, for example, an acceptance unit (not shown) that accepts a change instruction from the user, and a change unit (not shown) that changes the information in accordance with the change instruction. The acceptance of the change instruction by the acceptance unit (not shown) may be, for example, acceptance from an input device, reception of information transmitted via a communication line, or acceptance of information read from a predetermined recording medium.

The present invention is not limited to the above embodiments, and various modifications are possible, and these are also encompassed within the scope of the present invention.

Embodiments constituted by appropriately changing combinations of constituent elements of the above-described embodiment and variations may be constituted. For example, without being limited to the configuration of the above-described embodiment itself, each constituent element of the above-described embodiment and variations may be replaced with other constituent elements as appropriate. Some of the constituent elements or functions of the above-described embodiment and variations may be omitted.

For example, in the above-described embodiment, the map rendering information is acquired from the map providing device, but the map rendering information may be stored in advance in the storage unit of the information processing apparatus or in the terminal storage unit of the terminal device itself. Furthermore, the feature information output unit may be provided in the terminal device, and in this case, information used by the feature information output unit may be transmitted from the information processing apparatus and the like to the terminal device, and the feature information output unit may be configured to output the output information using the transmitted information at the terminal device. The feature information acquisition unit may be provided in the terminal device.

The information processing system according to the above-described embodiment can be described as an information processing system including an information processing apparatus and a terminal device communicable with the information processing apparatus and corresponding to one user identifier, the information processing system including: a storage unit in which group feature information is stored, the group feature information being associated with a group identifier corresponding to two or more user identifiers and being feature information regarding a map feature that has been previously recorded based on a state or an action of a user; a feature information acquisition unit that acquires, from the storage unit, the group feature information corresponding to the group identifier corresponding to the user identifier corresponding to the terminal device; an output information acquisition unit that acquires the acquired group feature information or information based on the group feature information as output information; a map rendering information acquisition unit that acquires map rendering information indicating a map; and a terminal output unit that outputs a map and information based on the output information to an output device provided in the terminal device, using the map rendering information and the output information. Here, for example, the source of the map rendering information is not limited to the map providing device, and the feature information acquisition unit and the feature information output unit may be provided in the terminal device or in the terminal device of another user.

Regarding the above-described embodiment, the following variation (referred to herein as a second variation for convenience) may further be considered. The configuration of the following second variation can also be combined with the configurations of the above-described embodiment and variations, and various modifications are possible, and these are also encompassed within the scope of the present disclosure.

### Second Variation

In the second variation, the basic configuration of the information processing apparatus 100 and other devices of the information processing system 1 is the same as that of the above-described embodiment. However, a part of the hardware configuration, functions, and the like may be different.

In the second variation, regarding the handling of feature information, extended feature information including activities of users related to specific features and communication content can be utilized. As a result, in addition to recording attributes and states of a feature, information such as user activity histories and communication content can be recorded and managed, and users belonging to a group or a subgroup can confirm the information. A user can newly accumulate (add) information to the extended feature information of the group to which the user belongs, or update the content of the extended feature information of the group. The extended feature information may also be described as a “work log” that records user activities and other information related to a feature.

The extended feature information can be described as feature information that includes a plurality of pieces of information regarding activities performed by one or a plurality of users and information regarding communications performed between a plurality of users. Individual pieces of information included in the extended feature information may be referred to as individual accumulated information. The extended feature information may also be described as information including a plurality of pieces of individual accumulated information regarding actions performed by a user regarding a feature and communications with other users. For example, notes from a user to other users, messages and reactions to be sent to other users, user activity records, information indicating the state of a feature and changes thereof, and the like can be recorded as individual accumulated information. The individual accumulated information may be characters, numbers, symbols, images (still images, moving images, and the like), sounds, flag values, or the like. The individual accumulated information may also be regarded as a type of feature information. The user-input feature information in the above-described embodiment can be regarded as corresponding to the individual accumulated information. The extended feature information may include a plurality of types of individual accumulated information that differ in format or purpose from each other. For example, memos recording in chronological order the content of work performed by a user at a certain point, a collection of photos of the relevant point, logs of related chats, or information in which these are mixed may correspond to the extended feature information.

Here, activities performed by a user include, in addition to performing work related to a feature, recording feature information about the feature and updating the feature information. That is, for example, recording information on a work point detail screen described later and changing the content may be regarded as activities of the user, and the fact that such recording or updating of information has been performed may be included as individual accumulated information in the extended feature information.

Furthermore, the user may be able to perform work of adding individual accumulated information to the extended feature information and work of changing the content of individual accumulated information included in the extended feature information, that is, work of updating the extended feature information. In this case, the user may be able to perform change work only on individual accumulated information that the user has added, or may be able to perform change work also on individual accumulated information added or the like by other users. In the case of this example, the extended feature information can be regarded as information constituting a page managed by a so-called wiki system.

Extended feature information for each group can be handled as being included in the group feature information. Group feature information including the extended feature information can be described as feature information including a plurality of pieces of information regarding activities of one or more users of the corresponding group or information regarding communications by users within the group. In the second variation, the group feature information can be regarded as being classified into information including the extended feature information associated with a feature (hereinafter referred to as second group feature information) and information not including the extended feature information (hereinafter referred to as first group feature information). By outputting such group feature information as output information, within the group, not only the position and state of a feature but also user activity histories, communication records, and state changes of a feature related to the feature, including photos, videos, sounds, and the like, can be handled for each feature.

In the second variation, the information processing apparatus 100 can be configured as follows to enable handling of such extended feature information and group feature information.

In the second variation, the feature information acceptance unit 145 accepts feature information input by a user in association with the group identifier corresponding to the user identifier, and accumulates group feature information in the feature information storage unit 113 based on the accepted feature information. When individual accumulated information is input as the feature information, the feature information acceptance unit 145 accumulates group feature information in the feature information storage unit 113 based on the accepted individual accumulated information. That is, the processing unit 140 accumulates, for example, the individual accumulated information input by the user so as to constitute a part of the extended feature information. For example, when text information such as a memo is input as individual accumulated information for a certain feature, the text information is accumulated in a state associated so as to become a part of the extended feature information corresponding to the feature. The individual accumulated information can be recorded in association with a user identifier and time information. One piece of extended feature information may include a plurality of such individual accumulated information input by the user and other individual accumulated information based on the user's actions. In this case, a plurality of individual accumulated information corresponding to one user may be included, individual accumulated information corresponding to each of many users may be included, or both may be included.

Furthermore, in the second variation, when such second group feature information including the extended feature information is stored in the feature information storage unit 113, the feature information output unit 161 outputs the second group feature information as output information to the destination user. The feature information output unit 161 may construct the output information such that the extended feature information included in the second group feature information can be displayed in chronological order to the destination user. For example, the output information is constructed such that each individual accumulated information included in the extended feature information is included in a state associated with its respective time information. By outputting the extended feature information that can thus be displayed in chronological order, the user can easily confirm the history of activities and communications recorded in the extended feature information in chronological order, and can easily grasp the flow of information related to a specific feature.

Furthermore, the feature information output unit 161 may output the extended feature information included in the second group feature information such that, for example, text information from oneself and text information from other users are displayed in a display mode corresponding to the respective associated users, such as by using different colors or display positions. As a result, information can be output so that it can be easily grasped from which user the information is. Furthermore, the feature information output unit 161 may construct the output information such that the extended feature information included in the second group feature information is displayed in a different display mode for each destination user. For example, the feature information output unit 161 may select, from among the individual accumulated information included in the extended feature information, those to be included in the output information according to the role of the user, the attribute value of a predetermined attribute regarding the user, and the like, and construct the output information including the selected individual accumulated information.

Such a configuration may also be described as follows. The extended feature information includes a plurality of pieces of user-input feature information input by a user in relation to a feature, the storage unit 110 stores time information that enables specification of the time at which each piece of user-input feature information was recorded in the feature information storage unit 113, the feature information acquisition unit 151 acquires group feature information and time information corresponding to one group identifier from the storage unit 110, and the feature information output unit 161 is configured to output output information capable of displaying information based on each of the plurality of pieces of user-input feature information in chronological order based on the information acquired by the feature information acquisition unit 151. Furthermore, the extended feature information includes user-input feature information input by each of a plurality of users in relation to a feature, and the feature information output unit 161 is configured to output output information capable of displaying information based on each of the plurality of pieces of user-input feature information in a display mode corresponding to the user who input the user-input feature information, based on the information acquired by the feature information acquisition unit 151.

Outputting such second group feature information including the extended feature information to users of the group can be effectively utilized for purposes such as sharing information within the group in situations such as when work is performed on a feature (i.e., when work is performed at a specific point). For example, when a plurality of members of the group work on one feature, by recording communication items, progress information, notes, and the like between users as extended feature information corresponding to the feature, information can be easily shared within the group (this may be called a work log function or a work point function).

In the second variation, in order to accept information to be added to the extended feature information of the second group feature information, the processing unit 140 and the feature information acceptance unit 145 may be configured as follows. That is, when a predetermined operation for starting information addition in association with the second group feature information is performed by the destination user for the output information corresponding to the second group feature information, the acceptance unit 130 accepts this. Then, the processing unit 140 performs addition preparation processing for adding individual accumulated information to the extended feature information that is included in the second group feature information and serves as the addition destination, based on the operation performed by the user. The addition preparation processing is, for example, processing of providing information (e.g., an input screen and the like) for the user to input or designate candidate individual accumulated information to be added to the terminal device 600 of the user, but is not limited thereto.

Here, assume a case where, as candidate individual accumulated information to be added, information that is associated in advance with position information indicating a specific position exists, and the addition preparation processing constitutes information for requesting the user to designate the information. In such a case, the processing unit 140 determines, based on the position information indicating the position of the point corresponding to the candidate individual accumulated information to be added, whether the individual accumulated information satisfies an addition condition regarding the position of the point corresponding to the second group feature information that includes the extended feature information to which the information is to be added, and performs the addition preparation processing based on the determination result. The addition condition is, for example, that the distance between the point corresponding to the candidate individual accumulated information to be added and the point corresponding to the second group feature information (the addition destination point) is within a predetermined value, but is not limited thereto.

As one example of such addition preparation processing, for example, processing of requesting the user to select a captured image to be added to the extended feature information can be performed. In this case, the processing unit 140 can limit the images that are candidates for addition to those that satisfy the addition condition. That is, the processing unit 140 can perform the addition preparation processing to have the user select images corresponding to points within a predetermined range from the point corresponding to the second group feature information of the addition destination. For example, the processing unit 140 performs processing to cause, on the terminal device 600, a screen for accepting an image designation operation by the user, in which only images within a predetermined range from the addition destination point among the captured images are included as candidates for addition. Here, the captured images may be images stored in the information processing apparatus 100, but may be limited to images stored in the terminal device 600 of the user. It is sufficient that the processing unit 140 can acquire the position information of each image to enable the above-described processing to be executed.

By performing such addition preparation processing, the user can easily designate, as individual accumulated information, information that has a high possibility of being related to the second group feature information of the addition destination, and add the information to the extended feature information.

When processing of requesting the user to select a captured image to be added to the extended feature information is performed, the terminal processing unit 640 of the terminal device 600 may, for example, perform the above-described operation instead of the above-described processing unit 140. That is, assume a case where information is displayed on the display device 662 based on the output information corresponding to the second group feature information including the extended feature information output from the information processing apparatus 100, and a predetermined operation is performed by the user in association with the output information. In this case, the terminal processing unit 640 performs addition preparation processing so as to request the user to select an image to be added to the extended feature information. The terminal processing unit 640 may perform the addition preparation processing so as to have the user select, from among the candidate images, images corresponding to points within a predetermined range from the point corresponding to the second group feature information.

In the configuration for realizing the functions of the second variation as described above, the following may further be applied.

For example, in the second variation, when first group feature information is near the second group feature information, the user may be able to add information included in the nearby first group feature information to the extended feature information included in the second group feature information by performing a predetermined operation in association with the second group feature information. Such a function of merging existing first group feature information already recorded for the same group into the second group feature information may be called a merge function, an absorption function, or a point memo import function.

Regarding such a function, when the user performs a predetermined merge operation in association with the second group feature information, the processing unit 140 may perform addition preparation processing for adding information included in the first group feature information stored in the storage unit 110 to the extended feature information as follows. That is, the processing unit 140 identifies first group feature information corresponding to a point within a predetermined range from the point of the addition destination corresponding to the second group feature information. Then, the processing unit 140 makes information included in the identified first group feature information candidates for addition to the extended feature information. In other words, the processing unit 140 determines, for each piece of first group feature information, whether the addition condition that the information is first group feature information corresponding to a point within a predetermined range from the addition destination point is satisfied. Then, the first group feature information that satisfies the addition condition is identified as a candidate for addition. Such addition preparation processing can be performed, for example, to present the first group feature information identified as a candidate for addition to the user and have the user decide whether to add it. The processing unit 140 may perform processing of automatically adding information included in the first group feature information identified by the addition preparation processing to the extended feature information included in the second group feature information. By performing such addition preparation processing together with the merge function, the user can easily add information included in the first group feature information that has a high possibility of being related to the second group feature information of the addition destination, as individual accumulated information, to the extended feature information. The user can register many pieces of first group feature information in advance, and then easily merge the first group feature information into the second group feature information corresponding to the main features in the vicinity and organize the information.

Furthermore, in the second variation, the feature information acceptance unit 145 may accept a predetermined conversion operation by the user with respect to the output information that is the first group feature information. For example, assume a case where a user sees that feature information has been recorded for a specific point and wishes to share the extended feature information about the feature within the group. In this case, the user can cause the processing unit 140 to perform processing of accumulating the second group feature information regarding the point in the feature information storage unit 113 by performing a predetermined conversion operation corresponding to the output information at the point. That is, when the predetermined conversion operation is performed, the processing unit 140 converts the first group feature information regarding the point into second group feature information, and enables information to be accumulated in the extended feature information included in the second group feature information. By configuring in this manner, existing feature information can be easily changed to be manageable with the extended feature information as needed (information conversion processing). When processing of accumulating the second group feature information based on the first group feature information is performed in this manner, the original first group feature information may be deleted. Deletion may mean that the corresponding information is deleted from the storage unit 110, or may mean that various controls are performed to make the information hidden on screens displayed to the user.

Furthermore, in the second variation, the processing unit 140 may perform aggregation processing that collectively handles a plurality of pieces of first group feature information corresponding to a plurality of points within a predetermined distance range as one piece of second group feature information including one piece of extended feature information. For example, the processing unit 140 may be configured to perform processing of accumulating second group feature information including extended feature information in which information included in each piece of first group feature information is aggregated in the storage unit 110 when a predetermined conversion operation is accepted in association with the output information of a plurality of pieces of first group feature information corresponding to respective points that are within a predetermined range of each other. For example, when feature information regarding a plurality of respective points is being output by the feature information output unit 161, and when it can be determined that those points are within a predetermined range of each other, the processing unit 140 accepts the predetermined conversion operation by the user. Upon accepting the predetermined conversion operation, the processing unit 140 generates extended feature information aggregating information regarding the map features at those points, and performs processing of accumulating the extended feature information as being included in the second group feature information in the storage unit 110. By thus aggregating information related to a plurality of points within a predetermined range and enabling information input by users within the group to be accumulated as extended feature information, management of activities and communications regarding features spanning not a single point but a certain area can be efficiently performed. The predetermined range may be set as appropriate. Furthermore, regardless of whether the range is within the predetermined range, first group feature information that satisfies predetermined conditions, such as being points designated by the user, may be merged and handled as second group feature information in this manner. The predetermined conversion operation may be accepted first, and then the presence or absence of feature information within the predetermined range or the identification of target feature information may be performed. When such aggregation processing is performed, the original first group feature information may be deleted. Deletion may mean that the corresponding information is deleted from the storage unit 110, or may mean that various controls are performed to make the information hidden on screens displayed to the user.

As the predetermined conversion operation, for example, a selection operation of a context menu that becomes executable upon performing a selection operation of a feature information or its point. Performing the predetermined conversion operation may also be described as giving a conversion instruction. Specifically, for example, it may be an operation in which the user selects a feature on the terminal device 600 and selects an option such as “add work log,” “convert to work point,” or “register activity history,” but is not limited thereto.

The flow of operations of the processing unit 140 in the second variation can be, for example, as follows. The following is an example focusing on the flow from when the processing unit 140 accepts input of feature information from the user to when extended feature information is accumulated and output information is output.

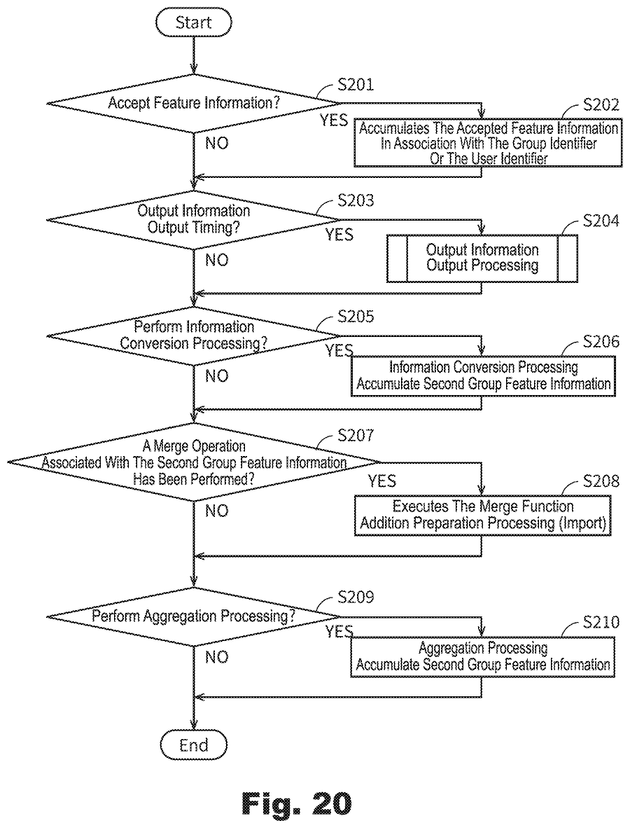

FIG. 20 is a flowchart showing an example of an operation of the information processing apparatus 100 according to the second variation of the present embodiment.

(Step S201) The processing unit 140 determines whether feature information has been accepted. When the processing unit 140 determines that feature information has been accepted by the feature information acceptance unit 145, the process proceeds to step S202. Otherwise, the process proceeds to step S203.

(Step S202) The processing unit 140 accumulates the feature information in the storage unit 110 based on the user identifier and the group identifier corresponding to the feature information. At this time, the processing unit 140 performs the accumulation operation as appropriate depending on whether the accepted feature information is individual accumulated information to be added to existing second group feature information or is first group feature information. The processing unit 140 may not perform such processing, and may accumulate the accepted feature information in the storage unit 110 as appropriate in association with information identifying the feature.

(Step S203) The processing unit 140 determines whether the output information output timing has arrived. When it is determined that the output information output timing has arrived, the process proceeds to step S204. Otherwise, the process proceeds to step S205.

(Step S204) The processing unit 140 performs output information output processing. As a result, group feature information corresponding to the group identifier is output to the user as described above. When the output information is output, each piece of feature information may be displayed as icons and the like as appropriate, and by performing an operation to display details thereof, detailed information of the feature information and the like may be displayed so that the user can grasp the content.

(Step S205) The processing unit 140 determines whether to perform information conversion processing. When it is determined to perform information conversion processing, the process proceeds to step S206. Otherwise, the process proceeds to step S207. The processing unit 140 determines, for example, that information conversion processing is to be performed when the first group feature information among the output information is designated and a predetermined conversion operation is performed.

(Step S206) The processing unit 140 performs information conversion processing and accumulates the second group feature information regarding the point corresponding to the first group feature information. As a result, from that point onward, information can be accumulated in the extended feature information included in the second group feature information regarding the point.

(Step S207) The processing unit 140 determines whether a merge operation associated with the second group feature information has been performed. That is, it determines whether to perform addition preparation processing for the merge function. When it is determined that a merge operation has been performed, the process proceeds to step S208. Otherwise, the process proceeds to step S209. The processing unit 140 determines, for example, that a merge operation has been performed when a predetermined operation is performed in association with the output information corresponding to the second group feature information, such as an operation of a point memo merging button described later.

(Step S208) The processing unit 140 executes the merge function. The processing unit 140 first performs addition preparation processing for adding information included in the first group feature information stored in the storage unit 110 to the extended feature information included in the second group feature information. That is, the processing unit 140 determines, for each piece of first group feature information, whether the addition condition that the information is first group feature information corresponding to a point within a predetermined range from the addition destination point is satisfied, and identifies first group feature information that satisfies the addition condition as a candidate for addition. Then, the processing unit 140, for example, presents the first group feature information identified as a candidate for addition to the user and has the user decide whether to add it. When an operation of deciding to add is accepted from the user, the processing unit 140 adds (merges) information included in the first group feature information to the extended feature information included in the second group feature information.

(Step S209) The processing unit 140 determines whether to perform aggregation processing. When it is determined to perform aggregation processing, the process proceeds to step S210. Otherwise, the series of processing is terminated. The processing unit 140 determines, for example, to perform aggregation processing when the points corresponding to a plurality of pieces of the first group feature information among the output information are within a predetermined range, and a predetermined conversion operation has been performed.

(Step S210) The processing unit 140 performs aggregation processing. That is, the processing unit 140 collectively accumulates the first group feature information at the respective points determined to be within the predetermined range as one piece of second group feature information. As a result, from that point onward, information can be aggregated as the second group feature information regarding the point. Thereafter, the series of processing is terminated.

According to the configuration of the second variation as described above, it becomes possible to comprehensively manage sharing of information related to specific points, recording of work, and history of communication between users, and to facilitate information sharing and decision-making within the group.

In the second variation, the extended feature information is associated with only one feature, but may be associated with two or more features. In this case, the feature to which the extended feature information corresponds may be described as a group of features that can be composed of two or more features.

In the second variation, when the second group feature information is output, for example, the following screens may be displayable on the terminal device 600. Such screens may be displayed by performing output of output information, acceptance of user operations, and the like between the information processing apparatus 100 and the terminal device 600 as appropriate. Hereinafter, specific examples of screen displays will be described.

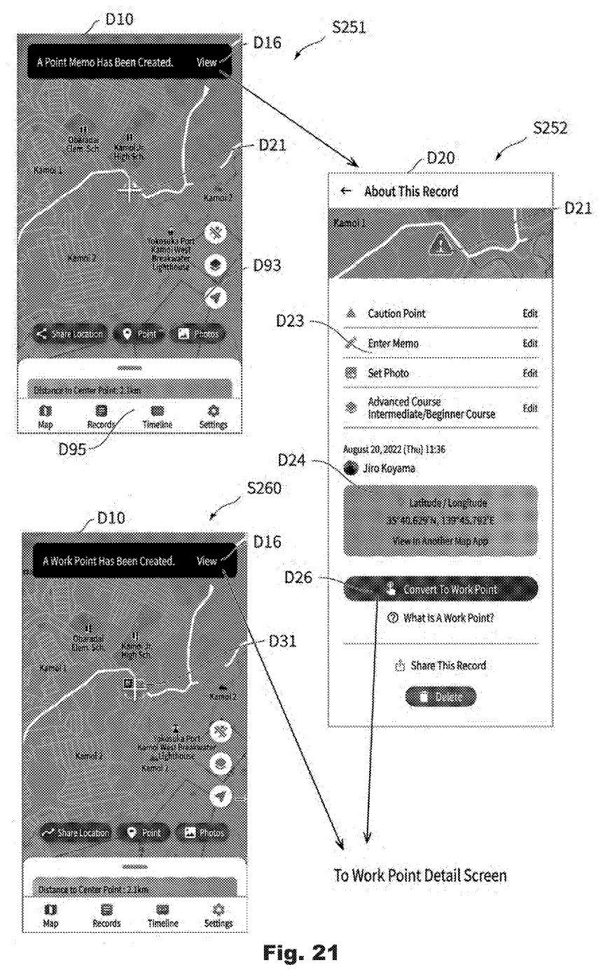

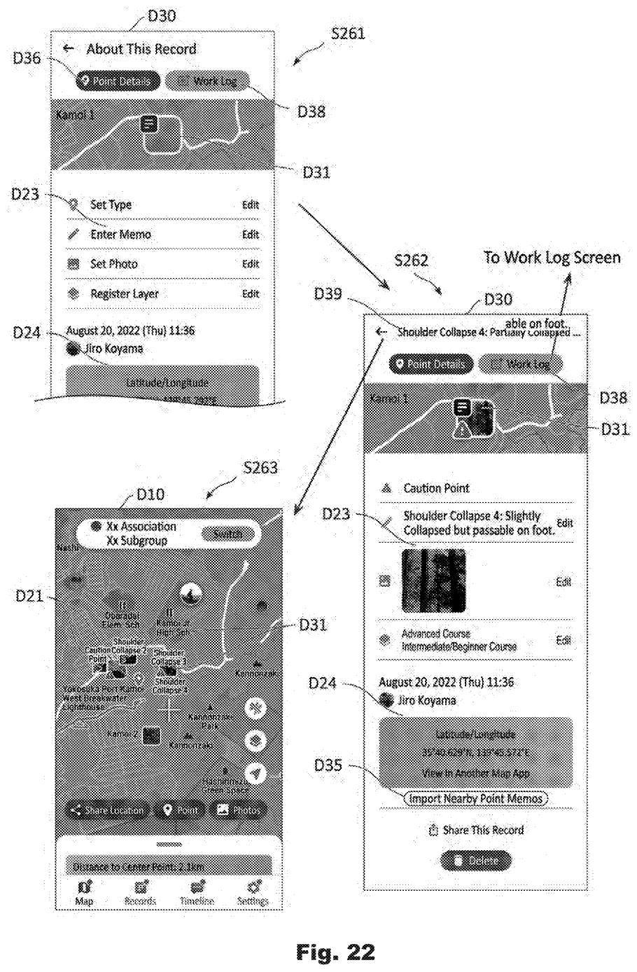

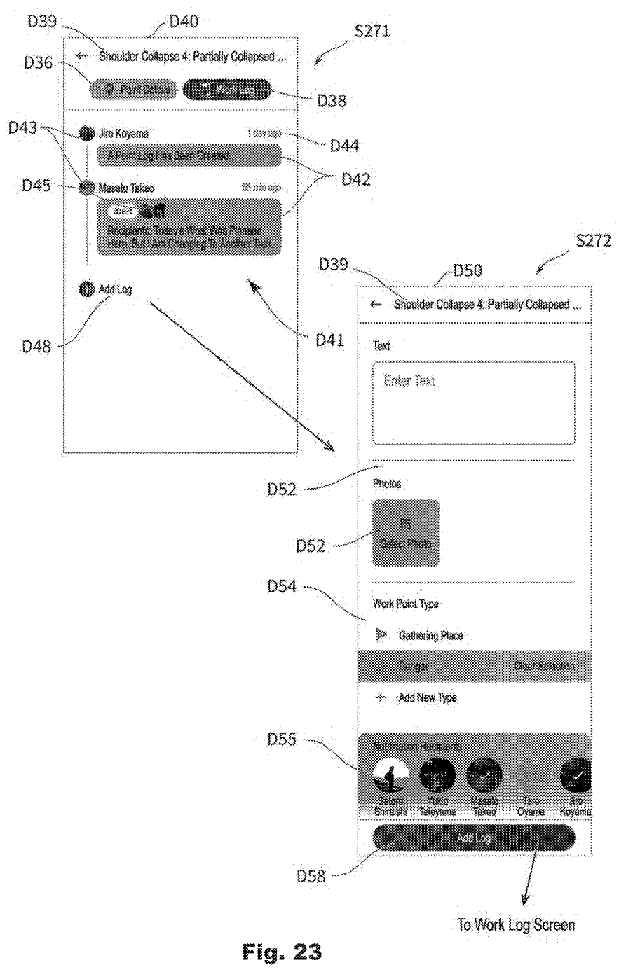

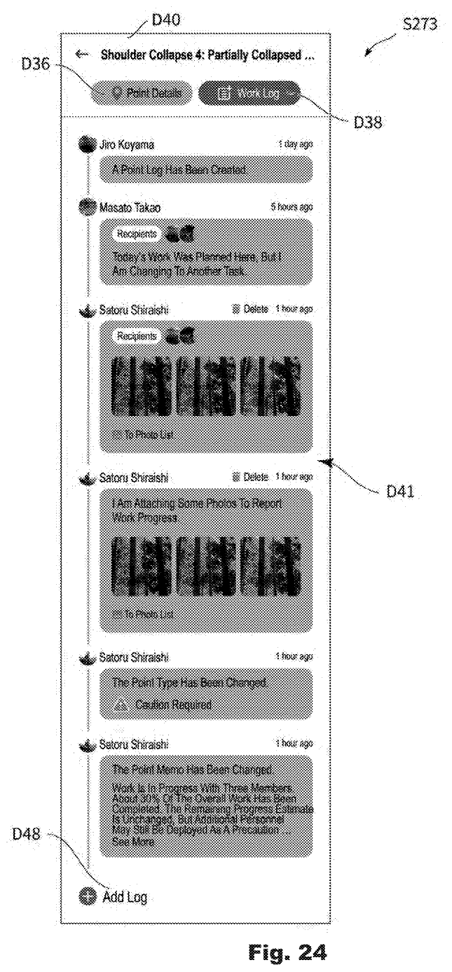

FIG. 21 is a first diagram illustrating screen display examples of an application operating on the terminal device 600 in the second variation. FIG. 22 is a second diagram illustrating screen display examples of the application. FIG. 23 is a third diagram illustrating screen display examples of the application. FIG. 24 is a fourth diagram illustrating screen display examples of the application.

In step S251, an example of a state in which a map display screen D10 is displayed on the display device 662 of the terminal device 600 of the user is shown. The map display screen D10 is a screen that, similarly to the map display screen C10 in the above-described embodiment, enables the user to confirm information based on the output information together with the map. The map display screen D10 also includes, similarly to the map display screen C10, operation images such as a feature information input button D93 and an information switching menu D95. Here, in particular, a screen display example at the timing when the user has recorded first group feature information (referred to here as a point memo) is shown, and the map display screen D10 includes a point memo marker D21 that is a marker indicating the position of the point memo on the map. When the confirmation button D16 provided in a message indicating that the recording of the point memo has been completed is operated, the screen transitions to a point memo screen D20 showing detailed information of the point memo (step S252).

As shown in step S252, the point memo screen D20 includes, for example, a point memo marker D21, an editing display section D23, and a recording information display section D24. The editing display section D23 is, for example, an area for accepting user information input or displaying recorded information for respective attributes such as the type of the point, memo content, photos, and layers to display. Such information can be treated as part of the feature information. The recording information display section D24 can display information indicating the user who recorded the point memo, information indicating the recording time, and the latitude and longitude of the point. On the point memo screen D20, feature information is thus displayed, so that feature information can be shared among users of the group as appropriate.

The point memo screen D20 includes a conversion button D26. When the conversion button D26 is operated, information conversion processing is performed and second group feature information (referred to here as a work point) is accumulated regarding the point corresponding to the point memo. In this example, when information conversion processing is performed on a point memo, the point memo is replaced with a work point, and thereafter the point memo is not displayed on the screen. When the conversion button D26 is operated, that is, when information conversion processing is performed, the screen transitions to a work point detail screen D30 showing detailed information of the work point.

In this example, the user can create a work point corresponding to a newly designated point, rather than converting from a point memo. For example, when the user performs an operation to create a work point on the map display screen D10, a work point marker D31 that is a marker indicating the position of the work point is displayed on the map of the map display screen D10 as shown in step S260. The work point marker D31 is a figure in which a display element that visually indicates that it is a work point is appended to at least a part thereof. Since the display element is appended in a common mode to a plurality of work points in the work point marker D31, the user can easily visually identify whether it is a work memo or other element or a work point. The work point marker D31 may be displayed in a specific color or a specific size so that it can be identified as a work point. When the confirmation button D16 provided in a message indicating that the accumulation of the work point has been completed is operated, the screen similarly transitions to the work point detail screen D30.

As shown in step S261, the work point detail screen D30 includes, for example, the work point marker D31, and an editing display section D23 and a recording information display section D24 similar to those displayed on the point memo screen D20. That is, on the work point detail screen D30, feature information about the work point is displayed, and the user can know its content. On the work point detail screen D30, for example, a detail screen selection button D36 and a work log selection button D38 are displayed so as to be mutually selectable. The detail screen selection button D36 is a button for displaying the work point detail screen D30 for the work point, and the work log selection button D38 is a button for displaying a work log screen D40 for the work point. The work log screen D40, as described later, is a screen for displaying and adding work logs. When the work log selection button D38 is operated, the screen transitions to the work log screen D40.

In step S261, when information input by the user is accepted using the editing display section D23, the work point detail screen D30 changes as shown in step S262. Here, an example is shown in which a memo (which may also be called a title) about the work point has been input, a photo has been set, a type has been set, and a layer has been set by the user. When a memo for the work point is input, its content is reflected in a title display section D39 at the top of the work point detail screen D30 and the work log screen D40. Furthermore, when a photo is set, the photo is displayed on the work point marker D31.

When a back button of the title display section D39 is operated on the work point detail screen D30 or the work log screen D40, the screen transitions to the map display screen D10 as shown in step S263. In the map display screen D10 of step S263, a point memo marker D21 representing a point memo and a work point marker D31 representing a work point are displayed, and the respective positions and whether each is treated as a point memo or a work point are identifiable.

In this example, the work point detail screen D30 displays an import nearby point memos button D35. The import nearby point memos button D35 is a button for using the above-described point memo import function. That is, the operation of the import nearby point memos button D35 corresponds to the predetermined operation for starting information addition in association with the second group feature information regarding the point memo import function. When the import nearby point memos button D35 is operated, the processing unit 140 performs the above-described addition preparation processing, and for example, a screen that accepts instructions to add information included in existing point memos within a predetermined range from the work point as the addition destination to a work log may be displayed. For example, information such as photos and memos included in an existing point memo can be merged as part of the information of the work point. The information of the point memo may be merged as information to be added to the work log, or may be merged as other feature information of the work point. When the addition preparation processing is performed, information of a work memo that matches a predetermined rule (e.g., being the work memo closest to the work point) may be added automatically. The operation for using the point memo import function may be accepted by a button or the like included in the work log screen D40, or may be accepted on the map display screen D10.

As shown in step S271, the work log screen D40 includes, similarly to the work point detail screen D30, the detail screen selection button D36, the work log selection button D38, and the title display section D39. The work log screen D40 displays a log display section D41. In the log display section D41, the content of the work log (an example of the extended feature information) is displayed as the extended feature information. The information processing apparatus 100 accumulates individual accumulated information input by users of the group as group feature information so as to constitute a part of the work log, and outputs the group feature information including the work log as output information, whereby the display content of the log display section D41 can be displayed.

In this example, the log display section D41 may include log content D42 representing the content of individual accumulated information added, that is, posted, by individual users. Information such as a posting user D43, a posting time D44, and a mention destination D45 may be included accompanying each log content D42. The log content D42 is information indicating posted text (messages and the like), photos, or user actions (such as records of operations to change values of specific attributes). The posting user D43 is information such as an icon or user name that enables identification of the user who input each post. The posting time D44 is information indicating the time at which each piece of individual accumulated information was accumulated. The mention destination D45 is information indicating the user specified as a mention destination at the time of user input, and is not displayed for posts in which no mention destination has been specified. In the log display section D41, these pieces of information are displayed in chronological order for each user's post.

Furthermore, the work log screen D40 displays a log addition button D48. When the log addition button D48 is operated, the screen transitions to a log input screen D50.

As shown in step S272, on the log input screen D50, an information input section D52, a specific attribute designation section D54, a member list D55, and an addition/submission button D58 are displayed. The submission button D58 is a button for designating information input on the log input screen D50 as individual accumulated information, and by operating the submission button D58, the information processing apparatus 100 accepts the individual accumulated information input by the user. When the submission button D58 is operated, the screen transitions to the work log screen D40. The information input section D52 is a part for accepting text and photos that the user designates as individual accumulated information. The specific attribute designation section D54 is a part for designating the attribute value of a specific attribute for the work point. Here, for example, acceptance of designation of type (an example of a specific attribute) such as whether it is a dangerous point or a gathering place is possible. The member list D55 is an area for accepting designation of a mention destination when a mention operation is performed. When individual accumulated information is input with a user designated as a mention destination, a notification in a specific mode (an example of output regarding feature information) is given to the user designated as the mention destination. The operation of the submission button D58 performed in a state where a mention destination is specified can be described as one of the mention operations.

The photo addition button D52 of the information input section D52 is a part for selecting a photo to be input as individual accumulated information. When the photo addition button D52 is operated, for example, a photo selection screen listing photos that the user can select as individual accumulated information is displayed. Here, the operation of the photo addition button D52 may correspond to the predetermined operation for starting information addition in association with the second group feature information. That is, when the photo addition button D52 is operated, the processing unit 140 may perform the above-described addition preparation processing. When the addition preparation processing is performed, for example, a photo selection screen in which only images within a predetermined range from the work point as the addition destination are selectable may be displayed. Furthermore, for example, a photo selection screen in which those images are selectable with priority over other images, for example, a photo selection screen in which candidate images are arranged in order of proximity to the work point, may be displayed. On the photo selection screen, the operation of enabling a predetermined display option may correspond to the predetermined operation. In this case, when the operation is performed, the addition preparation processing is performed, and the display mode of the photo selection screen changes in accordance with the result. When the addition preparation processing is performed, images matching a predetermined rule (e.g., being an image at the point closest to the work point) may be added automatically.

Step S273 is a display example of the work log screen D40 after a plurality of pieces of individual accumulated information have been input for the work point from the state shown in step S271. As shown here, the log display section D41 displays, for the work point, individual accumulated information resulting from operations of respective users of the group in chronological order. The individual accumulated information includes, for example, text, photos, and records of user actions such as records of operations to change attribute values of specific attributes. Since each piece of individual accumulated information is displayed together with the posting user D43 and the posting time D44, the user can easily grasp when and which member input the log content D42. As the work log, information automatically recorded along with user actions, such as trajectories, may also be included.

The aggregation processing may be performed, for example, as follows.

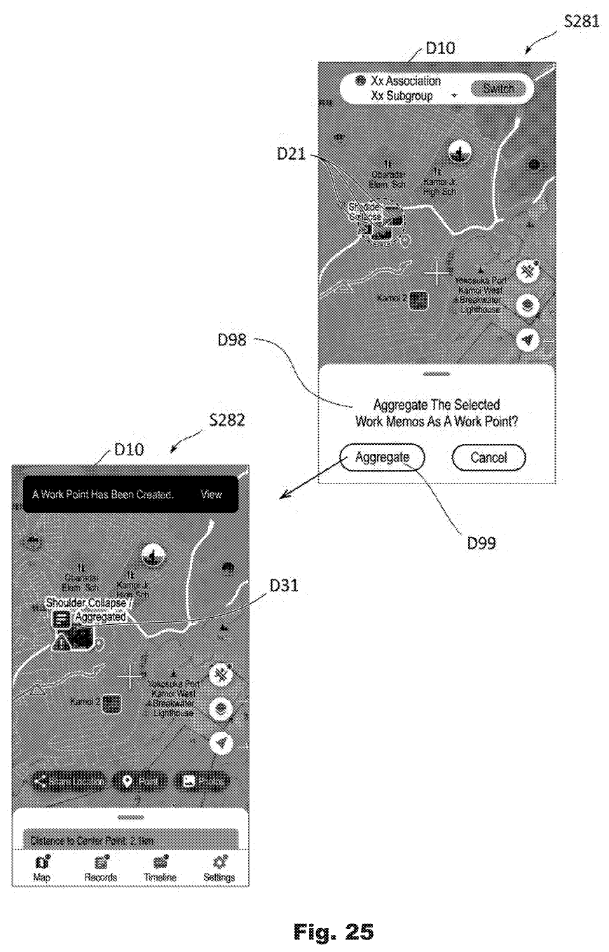

FIG. 25 is a fifth diagram illustrating screen display examples of the application.

In step S281, for example, an example of the map display screen D10 in which aggregation processing is acceptable in a state where a plurality (e.g., three) of nearby point memos have been recorded is shown. Here, for example, a state in which these point memos have been selected by the user as targets for aggregation processing is shown, and dashed lines are displayed so as to surround the point memo markers D21 corresponding to the respective point memos. The dashed lines may not be displayed. In this state, the map display screen D10 displays an aggregation processing instruction section D98 for accepting the aggregation processing. The aggregation processing instruction section D98 includes a display explaining that the selected point memos are to be aggregated as a work point, and a decision button D99. The user can cause the aggregation processing to be performed by operating the decision button D99.

When the decision button D99 is operated, the state transitions to the state shown in step S282. That is, in step S282, the selected point memos are aggregated and handled as one work point, and a work point marker D31 indicating the work point is displayed. The display mode of the work point in this case is not limited to such a work point marker D31. For example, the display may be in another mode that makes it possible to grasp that the work point was created based on a plurality of point memos, or a marker or the like indicating a work point may be displayed separately at the position corresponding to each point memo.

Elements shown in the specific examples of screen displays described above may be used in the screen displays of the above-described embodiment as appropriate in accordance with related functions, or may be deleted from the screen, replaced with other elements, or displayed in other known modes. For example, the point memo screen D20 may be adopted as a screen for displaying and editing information regarding the group feature information in the above-described embodiment.

In the second variation, regarding the information processing apparatus 100, the following aspects may also be described.

An information processing apparatus according to aspect 1 is an information processing apparatus including: a storage unit in which group feature information is stored, the group feature information being associated with a group identifier corresponding to two or more user identifiers and being feature information regarding a map feature that has been previously recorded based on a state or an action of a user; a feature information acquisition unit that acquires, from the storage unit, the group feature information corresponding to the group identifier corresponding to the user identifier, by using the user identifier of a destination user; and a feature information output unit that outputs the acquired group feature information or information based on the group feature information as output information in association with the destination user.

An information processing apparatus according to aspect 2 is the information processing apparatus according to aspect 1, wherein the storage unit stores the group feature information including extended feature information, and the extended feature information is the feature information that can be configured to include a plurality of pieces of information regarding activities of one or more users of the corresponding group or information regarding communications by users within the group.

An information processing apparatus according to aspect 3 is the information processing apparatus according to aspect 2, wherein the feature information output unit is configured to output, to the destination user, the output information capable of displaying each of the plurality of pieces of information included in the extended feature information in chronological order.

An information processing apparatus according to aspect 4 is the information processing apparatus according to aspect 2, wherein the feature information output unit is configured to output, to the destination user, the output information capable of displaying each of the plurality of pieces of information included in the extended feature information in a display mode corresponding to the user associated with the information.

An information processing apparatus according to aspect 5 is the information processing apparatus according to aspect 2, including a processing unit that performs addition preparation processing for adding information to the extended feature information, based on an operation performed by the destination user in association with the output information corresponding to the group feature information including the extended feature information, wherein the processing unit is configured to determine, based on position information indicating a position corresponding to candidate information to be added, whether the information satisfies an addition condition regarding the position of the point corresponding to the group feature information, and to perform the addition preparation processing based on the determination result.

An information processing apparatus according to aspect 6 is the information processing apparatus according to aspect 5, wherein the addition preparation processing is processing of requesting the user to select an image to be added to the extended feature information, and the processing unit performs the addition preparation processing such that images corresponding to points within a predetermined range from the point corresponding to the group feature information are selectable by the user.

An information processing apparatus according to aspect 7 is the information processing apparatus according to aspect 5, wherein the group feature information is either first group feature information not including the extended feature information or second group feature information including the extended feature information, the processing unit is configured to perform addition preparation processing for adding information included in the first group feature information stored in the storage unit to the extended feature information, based on an operation performed by the destination user in association with the output information corresponding to the second group feature information, and the processing unit performs the addition preparation processing so as to make information included in first group feature information corresponding to a point within a predetermined range from the point corresponding to the second group feature information a candidate for addition.

An information processing apparatus according to aspect 8 is the information processing apparatus according to aspect 2, wherein the group feature information is either first group feature information not including the extended feature information or second group feature information including the extended feature information, the information processing apparatus including a processing unit that, when a predetermined conversion operation associated with the output information corresponding to the first group feature information is accepted, the predetermined conversion operation being performed by the destination user for the output information, accumulates the second group feature information corresponding to the output information in the storage unit, and performs processing to enable information to be accumulated in the extended feature information included in the second group feature information.

An information processing apparatus according to aspect 9 is the information processing apparatus according to aspect 8, wherein the processing unit is configured to, when the predetermined conversion operation is accepted in association with the output information of a plurality of pieces of the first group feature information corresponding to respective points that are within a predetermined range of each other, perform processing of accumulating in the storage unit the second group feature information including the extended feature information in which information included in each of the first group feature information is aggregated.

A terminal device according to aspect 10 is a terminal device including: a display device; a map rendering information acquisition unit that acquires map rendering information indicating a map; an output information acquisition unit that acquires output information corresponding to the group feature information including the extended feature information, the output information being output from the information processing apparatus according to aspect 2 described above; a terminal output unit that causes the display device to display information such that information based on the output information is displayed on the map, using the map rendering information and the output information; and a terminal processing unit that performs addition preparation processing of requesting the user to select an image to be added to the extended feature information, based on an operation performed by the user in association with the output information, wherein the terminal processing unit performs the addition preparation processing such that, among candidate images to be added, images corresponding to points within a predetermined range from the point corresponding to the group feature information are selectable by the user.

### INDUSTRIAL APPLICABILITY

As described above, the information processing apparatus according to the present disclosure has the effect of being able to share data on a map within a group including a plurality of users, and is useful as an information processing apparatus and the like.

1. A computer-implemented information processing apparatus comprising:
one or more memories storing group feature information in association with a group identifier corresponding to two or more user identifiers, the group feature information including feature information relating to a map feature and being recorded based at least in part on a state or an action of a user of a group corresponding to the group identifier; and
one or more processors configured to:
identify, using a user identifier of a destination user, a group identifier corresponding to the user identifier of the destination user;
acquire, from the one or more memories, group feature information associated with the identified group identifier; and
generate output information for the destination user, the output information being for causing a terminal device corresponding to the destination user to present, on a map, the acquired group feature information or information generated based on the acquired group feature information.

2. The information processing apparatus of claim 1,
wherein the group feature information includes extended feature information corresponding to a particular map feature,
wherein the extended feature information is configured to include a plurality of pieces of individual accumulated information each relating to at least one of:
(i) an operation by a user of the group to set an attribute value of a specific attribute for the particular map feature;
(ii) an activity of a user of the group; or
(iii) communication by a user within the group, and
wherein the one or more processors are configured to generate the output information so that the plurality of pieces of individual accumulated information are displayable in chronological order in association with information identifying users associated with the respective pieces of individual accumulated information.

3. The information processing apparatus of claim 2,
wherein each of the plurality of pieces of individual accumulated information is stored in association with a user identifier and time information, and
wherein the output information includes information for displaying each piece of individual accumulated information in association with a posting user and a posting time.

4. The information processing apparatus of claim 2,
wherein at least one of the plurality of pieces of individual accumulated information includes text information, image information, or information indicating a change in an attribute value of the particular map feature.

5. The information processing apparatus of claim 2,
wherein the one or more processors are configured to:
accept an operation performed by the destination user in association with the output information corresponding to the group feature information including the extended feature information; and
perform addition preparation processing for adding candidate information to the extended feature information based on the operation.

6. The information processing apparatus of claim 5,
wherein the candidate information is associated with position information indicating a position corresponding to the candidate information, and
wherein the one or more processors are configured to determine, based on the position information, whether the candidate information satisfies an addition condition relating to a position of the particular map feature corresponding to the extended feature information, and to perform the addition preparation processing based on a result of the determination.

7. The information processing apparatus of claim 6,
wherein the addition condition includes a condition that a distance between the position corresponding to the candidate information and the position of the particular map feature is within a predetermined distance, and
wherein the addition preparation processing includes causing the terminal device to present, as selectable candidate information, information satisfying the addition condition.

8. The information processing apparatus of claim 2,
wherein the one or more memories store first group feature information that does not include extended feature information and second group feature information that includes extended feature information, and
wherein the one or more processors are configured to, when a predetermined conversion operation associated with output information corresponding to the first group feature information is accepted from the destination user, accumulate, in the one or more memories, second group feature information corresponding to the first group feature information, and enable information to be accumulated in the extended feature information included in the second group feature information.

9. The information processing apparatus of claim 8,
wherein, when the predetermined conversion operation is accepted in association with output information corresponding to a plurality of items of first group feature information corresponding to respective points within a predetermined range of each other, the one or more processors are configured to accumulate second group feature information including extended feature information in which information included in the plurality of items of first group feature information is aggregated.

10. The information processing apparatus of claim 1,
wherein the one or more processors are further configured to:
acquire input rule information that specifies at least one predetermined attribute for which an attribute value is recordable in association with a map feature;
generate rule application information based on the input rule information, the rule application information being used for accepting input of an attribute value of the predetermined attribute in association with the map feature; and
accumulate, in the one or more memories as at least part of the group feature information, an attribute value input by a user based on the rule application information in association with the group identifier corresponding to the user identifier of the user.

11. The information processing apparatus of claim 10,
wherein the input rule information includes information defining at least one of a data type of the attribute value or a constraint on input of the attribute value,
wherein the rule application information includes a determination condition for determining whether the attribute value input by the user is acceptable, and
wherein the one or more processors are configured to accumulate, in the one or more memories, the attribute value determined to be acceptable based on the determination condition.

12. The information processing apparatus of claim 11,
wherein the input rule information defines a plurality of predetermined attribute values selectable as options for the predetermined attribute, and
wherein the rule application information includes information for configuring an input form including a selection input portion by which one of the plurality of predetermined attribute values is selectable.

13. The information processing apparatus of claim 2,
wherein the one or more processors are further configured to:
output, to the destination user, a member list including user identifiers of one or more other users associated with the identified group identifier;
accept a mention operation performed by the destination user, the mention operation designating at least one of the other users identified by the member list as a mention destination and designating information relating to the particular map feature to be output to the mention destination in association with the extended feature information or the individual accumulated information; and
output, to the at least one user designated as the mention destination, information corresponding to the mention operation.

14. A method performed by an information processing apparatus including one or more memories and one or more processors, the method comprising:
storing, by the information processing apparatus in the one or more memories, group feature information in association with a group identifier corresponding to two or more user identifiers, the group feature information including feature information relating to a map feature and being recorded based at least in part on a state or an action of a user of a group corresponding to the group identifier;
identifying, by the information processing apparatus using a user identifier of a destination user, a group identifier corresponding to the user identifier of the destination user;
acquiring, by the information processing apparatus from the one or more memories, group feature information associated with the identified group identifier, the group feature information including extended feature information corresponding to a particular map feature; and
generating, by the information processing apparatus, output information for the destination user so that a terminal device corresponding to the destination user presents, on a map, the acquired group feature information or information generated based on the acquired group feature information,
wherein the extended feature information is configured to include a plurality of pieces of individual accumulated information each relating to at least one of:
(i) an operation by a user of the group to set an attribute value of a specific attribute for the particular map feature;
(ii) an activity of a user of the group; or
(iii) communication by a user within the group, and
wherein the output information is generated so that the plurality of pieces of individual accumulated information are displayable in chronological order in association with information identifying users associated with the respective pieces of individual accumulated information.

15. A non-transitory computer-readable storage medium storing instructions that, when executed by one or more processors of an information processing apparatus, cause the information processing apparatus to perform operations comprising:
identifying, using a user identifier of a destination user, a group identifier corresponding to the user identifier of the destination user;
acquiring, from one or more memories of the information processing apparatus, group feature information associated with the identified group identifier, the group feature information including feature information relating to a map feature and being recorded based at least in part on a state or an action of a user of a group corresponding to the identified group identifier; and
generating output information for the destination user so that a terminal device corresponding to the destination user presents, on a map, the acquired group feature information or information generated based on the acquired group feature information,
wherein the group feature information includes extended feature information corresponding to a particular map feature,
wherein the extended feature information is configured to include a plurality of pieces of individual accumulated information each relating to at least one of:
(i) an operation by a user of the group to set an attribute value of a specific attribute for the particular map feature;
(ii) an activity of a user of the group; or
(iii) communication by a user within the group, and
wherein the output information is generated so that the plurality of pieces of individual accumulated information are displayable in chronological order in association with information identifying users associated with the respective pieces of individual accumulated information.
